(19) United States
(12) Patent Application Publication
(10) Pub. No.: US 2018/0293789 A1
(43) Pub. Date: Oct. 11, 2018

(54) THREE-DIMENSIONAL GEOMECHANICAL MODELING OF CASING DEFORMATION FOR HYDRAULIC FRACTURING TREATMENT DESIGN

(71) Applicant: HALLIBURTON ENERGY SERVICES, INC., Houston, TX (US)

(72) Inventors: Xinpu Shen, Houston, TX (US); William Standifird, Fulshear, TX (US); Guoyang Shen, Houston, TX (US)

(21) Appl. No.: 15/765,218

(22) PCT Filed: Nov. 2, 2015
(86) PCT No.: PCT/US15/58648

§ 371 Date: Mar. 30, 2018

(51) Int. Cl. G06T 17/05; G06G 7/57; G06G 7/50

(52) U.S. Cl. CPC G06T 17/05; E21B 47/02208; G06G 7/50; G06G 7/57

(57) ABSTRACT

System and methods of modeling casing deformation for hydraulic fracturing design are provided. A three-dimensional (3D) global model of a subsurface formation is generated. Values of material parameters for different points of the subsurface formation represented by the 3D global model are calculated based on a geomechanical analysis of well log data obtained for the subsurface formation. The calculated values are assigned to corresponding points of the global model. A 3D sub-model of a selected portion of the formation including a casing to be placed along a planned trajectory of a wellbore is generated based at least partly on the values assigned to the global model. Numerical damage models are applied to the global model and sub-model to simulate effects of a hydraulic fracturing treatment on the formation and casing along the planned wellbore trajectory. Casing deformation along the planned wellbore trajectory is estimated, based on the simulation.

### FIELD OF THE DISCLOSURE

The present disclosure relates generally to the design of hydraulic fracturing treatments for stimulating hydrocarbon production from subsurface reservoirs, and particularly, to design techniques for mitigating casing failure during hydraulic fracturing treatments.

### BACKGROUND

In the oil and gas industry, a well that is not producing as expected may need stimulation to increase the production of subsurface hydrocarbon deposits, such as oil and natural gas. Hydraulic fracturing has long been used as a major technique for well stimulation. The rapid development of unconventional resources in recent years has led to a renewed interest in hydraulic fracturing, and multistage hydraulic fracturing in particular. Examples of such unconventional resources include, but are not limited to, oil and/or natural gas trapped within tight sand, shale, or other type of impermeable rock formation. A multistage hydraulic fracturing operation may involve drilling a horizontal wellbore and applying a series of stimulation injections along the wellbore over multiple stages.

A key factor to the success of such a hydraulic fracturing operation is maintaining casing integrity along the wellbore during each stage of the operation. Significant casing deformation in a section of the wellbore can hinder or even stop the progress of the hydraulic fracturing operation altogether. For example, such casing deformation may prevent the removal of bridge plugs or other operational work that may need to be performed for that section before the operation can proceed to other sections of the wellbore. Consequently, several well sections or even the entire well may have to be abandoned due to any casing deformation that may occur before all stages of the hydraulic fracturing operation have been completed.

Therefore, an effective design for a multistage hydraulic fracturing operation should account for the potential casing deformation that may occur during different stages of the operation. Such an effective hydraulic fracturing design may then be used to mitigate the chances of a costly failure in the casing during the actual operation.

### BRIEF DESCRIPTION OF THE DRAWINGS

FIG. 1 is a diagram of an illustrative well system for hydraulically fracturing a subterranean formation.

FIGS. 2A and 2B are different views of an asymmetric distribution of fractures induced by hydraulic fracturing within a subterranean formation relative to a trajectory of a wellbore drilled through the formation.

FIG. 3 is a diagram illustrating the location of casing deformation caused by hydraulic fracturing along the trajectory of a wellbore.

FIG. 4 is a diagram illustrating different stages of a hydraulic fracturing treatment design along a planned trajectory of a horizontal wellbore within a subsurface formation.

FIG. 5 is a flowchart for an illustrative process of modeling casing deformation for improved hydraulic fracturing treatment design and analysis.

FIG. 6 is a graph showing different injection pressures during a stage of a multistage hydraulic fracturing treatment.

FIG. 7 is a diagram of an illustrative three-dimensional (3D) global model of a subsurface formation.

FIG. 8 is a diagram of an illustrative 3D sub-model of a portion of the subsurface formation modeled in FIG. 7.

FIG. 9 is a diagram showing a cross-sectional view of a portion of the 3D sub-model of FIG. 8 for estimating casing deformation along a planned trajectory of a horizontal wellbore.

FIGS. 10A and 10B are 3D meshes illustrating estimated values of casing deformation with relatively high quality cementing material along the horizontal wellbore.

FIGS. 11A and 11B are 3D meshes illustrating estimated values of casing deformation with relatively low quality cementing material along the horizontal wellbore.

FIG. 12 is a block diagram of an illustrative computer system in which embodiments of the present disclosure may be implemented.

### DESCRIPTION OF ILLUSTRATIVE EMBODIMENTS

Embodiments of the present disclosure relate to modeling casing deformation for improved hydraulic fracturing design. While the present disclosure is described herein with reference to illustrative embodiments for particular applications, it should be understood that embodiments are not limited thereto. Other embodiments are possible, and modifications can be made to the embodiments within the spirit and scope of the teachings herein and additional fields in which the embodiments would be of significant utility. Further, when a particular feature, structure, or characteristic is described in connection with an embodiment, it is submitted that it is within the knowledge of one skilled in the relevant art to effect such feature, structure, or characteristic in connection with other embodiments whether or not explicitly described.

It would also be apparent to one of skill in the relevant art that the embodiments, as described herein, can be implemented in many different embodiments of software, hardware, firmware, and/or the entities illustrated in the figures. Any actual software code with the specialized control of hardware to implement embodiments is not limiting of the detailed description. Thus, the operational behavior of embodiments will be described with the understanding that modifications and variations of the embodiments are possible, given the level of detail presented herein.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

As will be described in further detail below, embodiments of the present disclosure utilize geomechanical modeling techniques to estimate the location and amount of casing deformation that may occur during one or more stages of a multistage hydraulic fracturing treatment operation within a subsurface formation. In one or more embodiments, three-dimensional (3D) models of the subsurface formation may be used to simulate the effects of hydraulic fracturing injection loads on the casing in one or more sections of a horizontal or deviated wellbore within the formation. Each section of the wellbore may correspond to, for example, a stage of the multistage hydraulic fracturing treatment. The results of the simulation may then be used to determine a maximum threshold value of safe hydraulic fracturing fluid injection pressures that can be used during a particular stage of the treatment without causing significant casing deformation along the wellbore. Such a maximum threshold value may represent, for example, the maximum hydraulic fracturing injection load that the casing in that section of the wellbore can withstand before undergoing significant casing deformation.

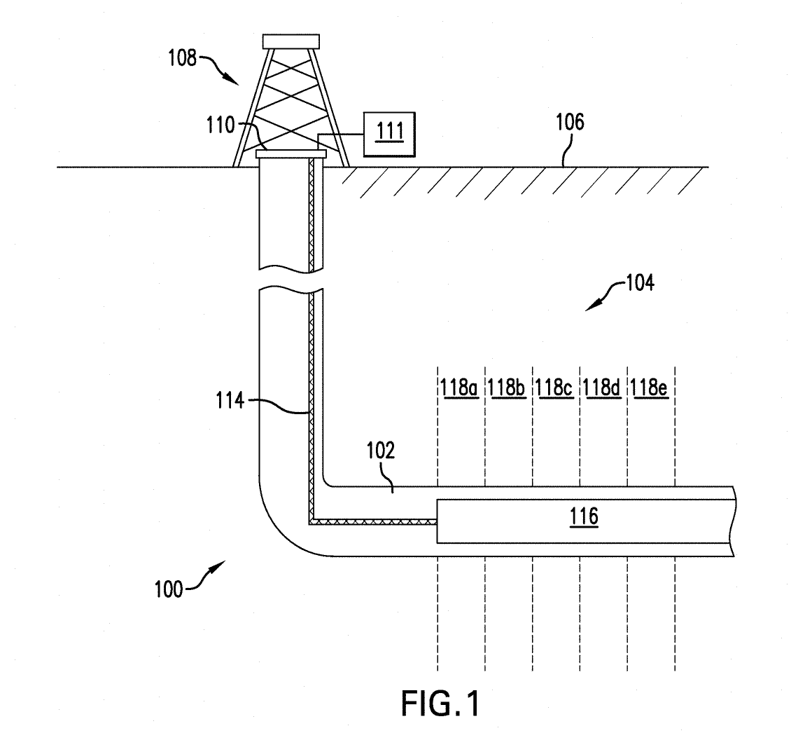

Illustrative embodiments and related methodologies of the present disclosure are described below in reference to FIGS. 1-12 as they might be employed, for example, in a computer system for modeling a subsurface formation and the effects of hydraulic fracturing treatment operations along a planned trajectory of a horizontal wellbore within the formation. In one or more embodiments, the computer system may be used to generate the aforementioned 3D models of the subsurface formation as part of a workflow for estimating casing deformation under different fluid injection pressures during the design and implementation of a multistage hydraulic fracturing treatment along the planned wellbore trajectory. Other features and advantages of the disclosed embodiments will be or will become apparent to one of ordinary skill in the art upon examination of the following figures and detailed description. It is intended that all such additional features and advantages be included within the scope of the disclosed embodiments. Further, the illustrated figures are only exemplary and are not intended to assert or imply any limitation with regard to the environment, architecture, design, or process in which different embodiments may be implemented.

FIG. 1 is a diagram illustrating an example of a well system 100 for performing a multistage hydraulic fracturing treatment of a subsurface formation. As shown in the example of FIG. 1, well system 100 includes a wellbore 102 in a subterranean region 104 beneath a surface 106 of the formation. The example wellbore 102 shown in FIG. 1 includes a horizontal wellbore. However, it should be appreciated that embodiments are not limited thereto and that well system 100 may include any combination of horizontal, vertical, slant, curved, and/or other wellbore orientations. The subterranean region 104 may include a reservoir that contains hydrocarbon resources, such as oil, natural gas, and/or others. For example, the subterranean region 104 may be a rock formation (e.g., shale, coal, sandstone, granite, and/or others) that includes hydrocarbon deposits, such as oil and natural gas. In some cases, the subterranean region 104 may be a tight gas formation that includes low permeability rock (e.g., shale, coal, and/or others). The subterranean region 104 may be composed of naturally fractured rock and/or natural rock formations that are not fractured to any significant degree.

Well system 100 also includes a fluid injection system 108 for injecting hydraulic fracturing fluid into the subterranean region 104 over multiple sections 118a, 118b, 118c, 118d, and 118e (collectively referred to as “sections 118”) of the wellbore 102, as will be described in further detail below. Each of the sections 118 may correspond to, for example, a different stage or interval of the multistage hydraulic fracturing injection treatment. The boundaries of the respective sections 118 and corresponding treatment stages/intervals along the length of the wellbore 102 may be delineated by, for example, the locations of bridge plugs, packers and/or other types of equipment in the wellbore 102. Additionally or alternatively, the sections 118 and corresponding treatment stages may be delineated by particular features of the subterranean region 104. Although five sections are shown in FIG. 1, it should be appreciated that any number of stages may be used as desired for a particular implementation. Furthermore, each of the sections 118 may have different widths or may be uniformly distributed along the wellbore 102.

As shown in FIG. 1, injection system 108 includes an injection control subsystem 111, a signaling subsystem 114 installed in the wellbore 102, and one or more injection tools 116 installed in the wellbore 102. The injection control subsystem 111 can communicate with the injection tools 116 from a surface 110 of the wellbore 102 via the signaling subsystem 114. Although not shown in FIG. 1, injection system 108 may include additional and/or different features for implementing the modeling and casing deformation estimation techniques disclosed herein. For example, the injection system 108 may include any number of computing subsystems, communication subsystems, pumping subsystems, monitoring subsystems, and/or other features as desired for a particular implementation.

During each stage of the hydraulic fracturing treatment, the injection system 108 may alter stresses and create a multitude of fractures in the subterranean region 104 by injecting hydraulic fracturing fluid into the surrounding rock formation along a portion of the wellbore 102 (e.g., along one or more of sections 118). The fluid may be injected through any combination of one or more valves of the injection tools 116. The injection tools 116 may include numerous components including, but not limited to, valves, sliding sleeves, ports, and/or other features that communicate fluid from a working string installed in the wellbore 102 into the subterranean region 104. The flow of fluid into the subterranean region 104 during one or more stages of the hydraulic fracturing treatment may be controlled by the configuration of the injection tools 116. For example, the valves, ports, and/or other features of the injection tools 116 can be configured to control the location, rate, orientation, and/or other properties of fluid flow between the wellbore 102 and the subterranean region 104. The injection tools 116 may include multiple tools coupled by sections of tubing, pipe, or another type of conduit. The injection tools may be isolated in the wellbore 102 by packers or other devices installed in the wellbore 102.

In some implementations, the injection system 108 may be used to create or modify a complex fracture network in the subterranean region 104 by injecting fluid into portions of the subterranean region 104 where stress has been altered. For example, the complex fracture network may be created or modified after an initial injection treatment has altered stress by fracturing the subterranean region 104 at multiple locations along the wellbore 102. After the initial injection treatment alters stresses in the subterranean formation, one or more valves of the injection tools 116 may be selectively opened or otherwise reconfigured to stimulate or re-stimulate specific intervals of the subterranean region 104, taking advantage of the altered stress state to create complex fracture networks. In some cases, the injection system 108 may inject fluid simultaneously for multiple intervals and sections 118 of wellbore 102.

In one or more embodiments, the injection tools 116 may include micro-seismic equipment, tiltmeters, pressure meters and/or other equipment to gather information relating to the extent of fracture growth and complexity during the hydraulic fracturing injection treatment. For example, the injection system 108 may utilize real time fracture mapping, real time fracturing pressure interpretation, and other data analysis techniques to monitor stress fields around hydraulic fractures based on the information gathered by the injection tools 116. Based on the monitoring, the injection system 108 may selectively control the valves of injection tools 116 in order to achieve desirable fracture geometries or help facilitate complex fracture growth. In one or more embodiments, the valves may also be selectively controlled to adjust the fluid injection pressure for one or more stages of the hydraulic fracturing injection treatment in order to prevent or mitigate any casing deformation that may occur along a trajectory of wellbore 102 within the subsurface formation, as will be described in further detail below.

The operation of the injection tools 116 may be controlled by injection control subsystem 111. The injection control subsystem 111 may include, for example, data processing equipment, communication equipment, and/or other systems that control injection treatments applied to the subterranean region 104 through the wellbore 102. The injection control subsystem 111 may receive, generate and/or modify an injection treatment plan that specifies properties of an injection treatment to be applied to the subterranean region 104. The injection control subsystem 111 may initiate control signals to configure the injection tools 116 and/or other equipment (e.g., pump trucks, etc.) to execute aspects of the injection treatment plan. The injection control subsystem 111 may receive data collected from the subterranean region 104 and/or another subterranean region by sensing equipment, and the injection control subsystem 111 may process the data and/or otherwise use the data to select and/or modify parameters of an injection treatment to be applied to the subterranean region 104. Accordingly, the injection control subsystem 111 may initiate additional control signals to reconfigure the injection tools 116 and/or other equipment based on selected and/or modified parameters.

The signaling subsystem 114 shown in FIG. 1 transmits signals from the wellbore surface 110 to one or more injection tools 116 installed in the wellbore 102. For example, the signaling subsystem 114 may transmit hydraulic control signals, electrical control signals, and/or other types of control signals. The control signals may include control signals initiated by the injection control subsystem 111. The control signals may be reformatted, reconfigured, stored, converted, retransmitted, and/or otherwise modified as needed or desired en route between the injection control subsystem 111 (and/or another source) and the injection tools 116 (and/or another destination). The signals transmitted to the injection tools 116 may control the configuration and/or operation of the injection tools 116. Examples of different ways to control the operation of each of the injection tools 116 include, but are not limited to, opening, closing, restricting, dilating, repositioning, reorienting, and/or otherwise manipulating one or more valves of the tool to modify the manner in which fluid is communicated into the subterranean region 104.

In one or more embodiments, the combination of injection valves of the injection tools 116 may be configured or reconfigured at any given time during the injection treatment. For example, the sequence of valve configurations can be predetermined as part of a treatment plan prior to implementation or adjusted in real time based on information gathered during the actual implementation of the treatment plan.

In one or more embodiments, the injection control subsystem 111 may be used to adjust the fluid injection pressure or rate for different stages of the hydraulic fracturing treatment in real time as the treatment plan is implemented. For example, the fluid injection pressure may be adjusted after one or more stages of the hydraulic fracturing treatment to prevent or mitigate potential casing deformation during later stages of the hydraulic fracturing treatment. In one or more embodiments, the injection control subsystem 111 may be used to estimate the location and extent of any casing deformation that may occur along the planned trajectory of the wellbore 102 under different hydraulic fracturing injection pressures. As will be described in further detail below, such casing deformation may be estimated based on a simulation of the effects of hydraulic fracturing injection treatment using 3D models of the subsurface formation. In one or more embodiments, the 3D models of the formation may be dynamically updated based on information gathered by the system 108 in real-time during one or more stages of the hydraulic fracturing treatment. The updated 3D models may then be used as part of a workflow for estimating the casing integrity and potential points of casing deformation that may occur along the wellbore trajectory planned for later treatment stages.

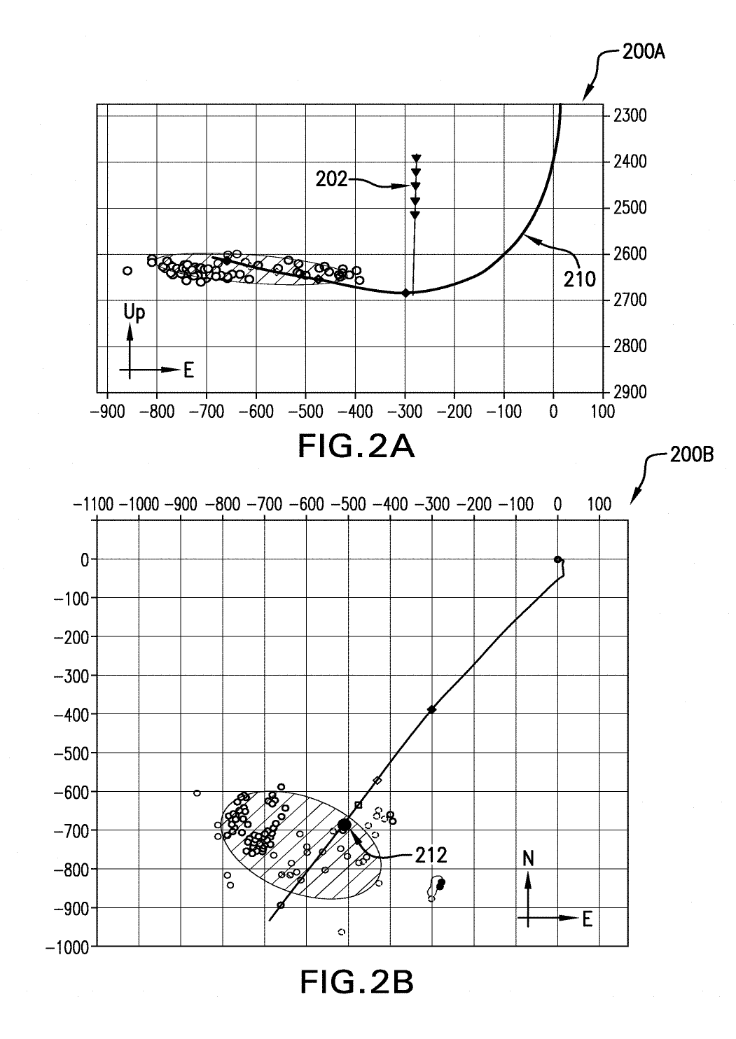

Examples of casing deformation that may occur along a wellbore trajectory are shown in FIGS. 2A, 2B, 3 and 4. It is assumed for purposes of the examples shown in each of FIGS. 2A, 2B, 3 and 4 that the wellbore trajectories and locations of hydraulic fracturing induced fractures and casing deformations along the respective wellbore trajectories are based on relevant measurements and data acquired during various stages of a multistage hydraulic fracturing treatment to stimulate the production of hydrocarbon resources, such as oil and/or natural gas, from subsurface formations.

FIGS. 2A and 2B are plot graphs illustrating different views of a horizontal wellbore trajectory and the locations of fractures induced by hydraulic fracturing injection within a subsurface formation. The subsurface formation may be, for example, a shale or other type of low permeability rock formation for which a hydraulic fracturing injection treatment is needed to stimulate the production of unconventional oil and/or natural gas resources from the formation. The locations of the hydraulic fracturing induced fractures in FIGS. 2A and 2B may be based on, for example, micro-seismic data acquired for different points within the formation. Such data may be acquired by, for example, downhole equipment, e.g., various measurement devices or sensors, disposed within an offset well 202, as shown in FIG. 2A. For example, sensors integrated within a drill string assembly disposed within well 202 may be used to acquire the micro-seismic data over a number of hydraulic fracturing treatment stages performed along multiple sections of the wellbore.

In FIG. 2A, a lateral view 200A of a wellbore trajectory 210 shows that the hydraulic fracturing induced fractures are distributed within substantially planar areas of the formation on opposite sides of the wellbore trajectory. In FIG. 2B, an overhead view 200B of the wellbore trajectory 210 also shows that the distributions of hydraulic fracturing induced fractures within the formation areas on either side are asymmetric relative to the wellbore trajectory. In particular, the overhead view of FIG. 2B shows that the majority of fractures are located in an area of the formation on one side of the wellbore trajectory, e.g., to the west of the wellbore trajectory. Therefore, it may be assumed that the distribution of natural fractures within the formation follow a similar asymmetric pattern relative to the wellbore trajectory.

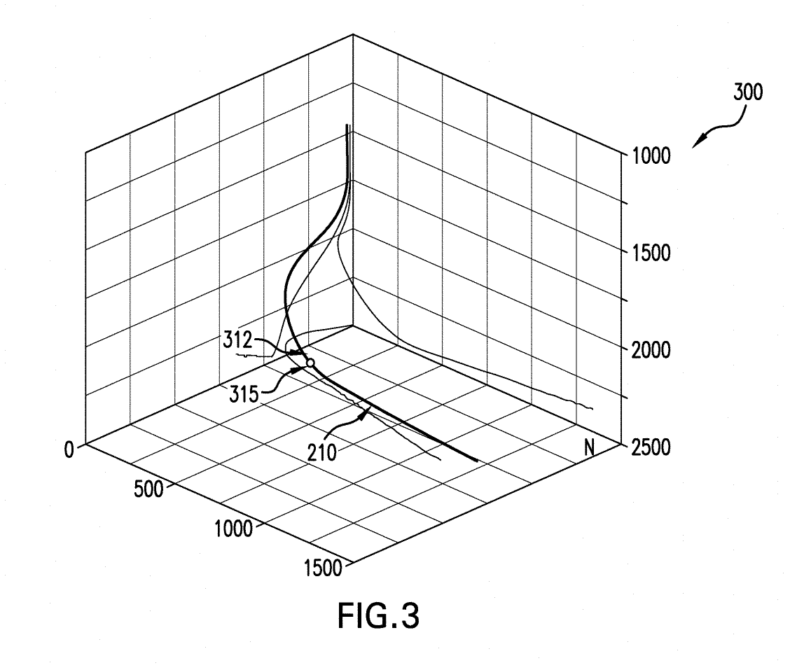

In addition to the asymmetric distribution of hydraulic fracturing induced fracture locations within the surrounding formation, FIG. 2B also shows a location 212 of significant casing deformation in a section of the horizontal wellbore toward the toe or leading end of the wellbore trajectory 210 within the formation. The location 212 and amount of the casing deformation may have been measured using, for example, downhole sensors or other measurement devices used to measure casing integrity or stress under hydraulic fracturing injection loads for the particular section of the wellbore during a corresponding stage of the hydraulic fracturing treatment. Such casing deformation may hinder or prevent the removal of any bridge plugs that were placed in the wellbore following perforation and fluid injection stimulation during the hydraulic fracturing treatment, as shown in FIG. 3.

FIG. 3 is a diagram illustrating a view 300 of a wellbore trajectory 310. In the example shown in FIG. 3, casing deformation due to hydraulic fracturing injection pressure occurs at a location 312 along the wellbore trajectory. The casing deformation at location 312 may prevent the removal of a bridge plug 315. Such casing deformation may therefore prevent any remaining stages of the hydraulic fracturing treatment in this example from being performed. In contrast with FIGS. 2A and 2B, the location of hydraulic fracturing induced casing deformation along the horizontal wellbore trajectory shown in the example of FIG. 3 is near the heel or trailing end of the trajectory within the formation.

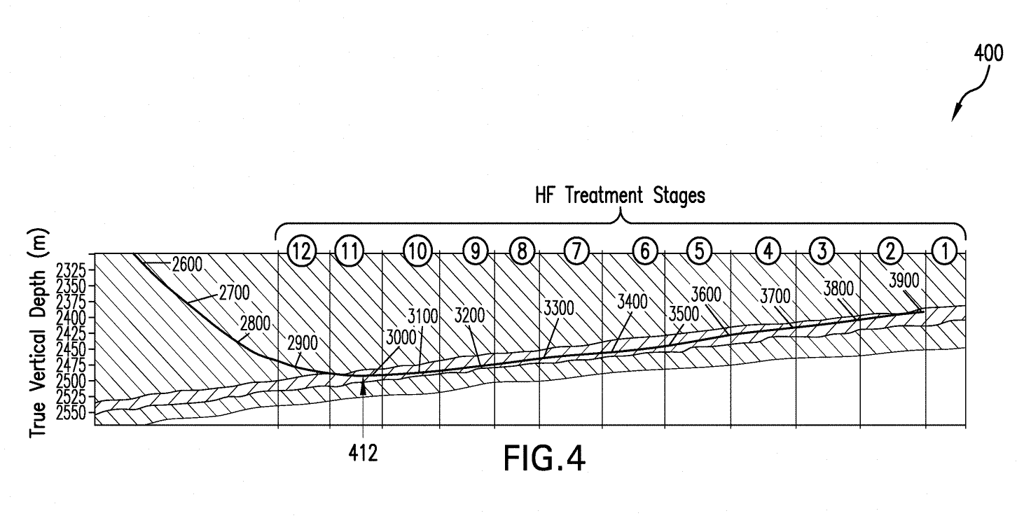

FIG. 4 is a diagram illustrating different stages of a hydraulic fracturing (HF) treatment design 400 along a planned trajectory of a horizontal wellbore within a subsurface formation. The subsurface formation may be, for example, tight gas formation, e.g., a coal, shale, or other type of rock formation, which includes unconventional hydrocarbon resources. While a total of twelve stages are shown in FIG. 4, it should be appreciated that embodiments are not limited thereto and that any number of stages may be used for the hydraulic fracturing treatment design. Similar to FIG. 3, the casing deformation in FIG. 4 occurs at a location 412 in a section of the wellbore near the heel of the wellbore trajectory corresponding to a stage 11 of the hydraulic fracturing treatment. As shown in FIG. 4, there is an asymmetric distribution of formation thickness relative to the wellbore trajectory at the heel in this section. Although the thickness of the formation area above the wellbore trajectory in this section increases with measured depth, this thickness remains relatively smaller than that of the formation area below.

The above-described examples of FIGS. 2A, 2B, 3 and 4 are illustrative of the following three major factors impacting casing deformation under hydraulic fracturing injection loads: (1) hydraulic fracturing fluid injection pressure and/or injection rate; (2) imperfections of cementing rings around the casing; and (3) asymmetric distribution of fractures caused by hydraulic fracturing injection along an axis of the casing. Of these three major factors, the amount of hydraulic fracturing injection pressure may be the primary cause of significant casing deformation along the wellbore. Also, any imperfections, gaps, or any lack of uniformity in the cementing material distributed around the casing may lead to non-uniform hydraulic fracturing injection loads that exacerbate deformation of the casing under hydraulic fracturing injection. Such imperfections may be due to the quality of the cementing material that forms the ring or the quality of cementing process that was used to distribute the material around the casing when the ring was formed. An asymmetric distribution of hydraulic fracturing induced fractures, the third major factor affecting casing deformation in the wellbore, may be due to an asymmetric distribution of natural fractures within the subsurface formation or other structural factors related to the wellbore and casing geometry. For example, areas of the formation where the density of natural fractures is relatively high tend to have relatively high permeability and relatively low formation strength. Such areas may therefore provide favorable conditions for the development and propagation of fractures within the formation. Further, since the casing geometry at the heel of the wellbore is in a curved shape, the distribution of fractures generated within the formation by any stages of the hydraulic fracturing injection treatment performed near the heel tend to be asymmetric to the curved casing.

While there may be other factors, such as mini-fault reactivation, which could also impact casing deformation during hydraulic fracturing injection treatment operations, such factors are generally regarded as being less significant or negligible relative to the above-listed factors. Therefore, such factors may be ignored for purposes of the casing deformation modeling techniques disclosed herein.

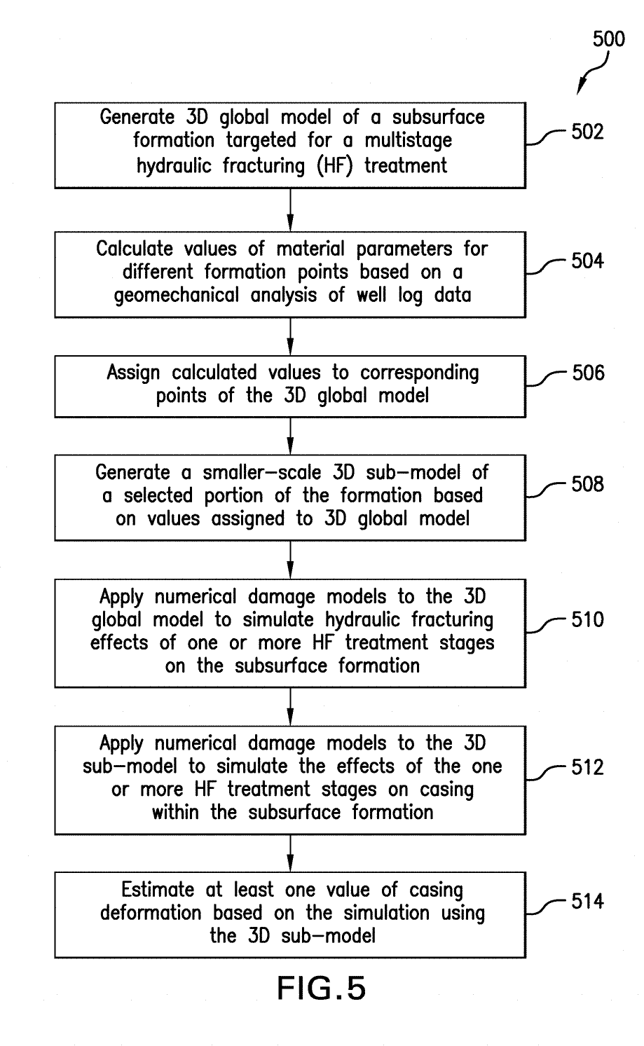

FIG. 5 is a flowchart for an illustrative process 500 of modeling casing deformation for improved hydraulic fracturing treatment design and analysis. For discussion purposes, process 500 will be described using well system 100 of FIG. 1, as described above. However, process 500 is not intended to be limited thereto. As will be described in further detail below, process 500 may be used to estimate the location and extent of casing deformation that may occur under hydraulic fracturing injection pressures associated with one or more stages of a multistage hydraulic fracturing treatment along a planned trajectory of horizontal wellbore (e.g., wellbore 102 of FIG. 1, as described above) within a subsurface formation. The subsurface formation may be, for example, a tight sand, shale, or other type of rock formation with trapped deposits of unconventional hydrocarbon resources, e.g., oil and/or natural gas. Accordingly, the subsurface formation or portion thereof may be targeted for the multistage hydraulic fracturing treatment in order to stimulate the production of such resources from the rock formation.

Process 500 begins in step 502, which includes generating a 3D global model of the subsurface formation. A bottom portion of the 3D global model may be used to represent, for example, the locations of well trajectory sites or areas of the formation targeted for hydraulic fracturing injection treatment. In one or more embodiments, the center of the bottom surface of the 3D global model may correspond to the location of the planned trajectory of the horizontal wellbore through the formation. A top portion of the global model may be used to represent one or more designated overburden layers of the formation. The height of the 3D global model may be based on, for example, a value of true vertical depth (TVD) measured from the ground surface to the location of the horizontal wellbore within the subsurface formation. As the 3D global model is designed to provide a 3D representation of the geo-stress distribution within the subsurface formation for simulation purposes, its size should be large enough for the simulation to be sufficiently accurate. However, for purposes of computational efficiency, the size of the 3D global model should be kept as small as possible. Thus, an optimal size of the 3D global model should account for both accuracy and efficiency.

As casing deformation is known to start at the ends of a perforation section, the dimensions of the 3D global model may be defined such that it represents at least one-half of the length of a hydraulic fracturing injection stage or interval of the hydraulic fracturing treatment along the wellbore trajectory. The length, width, and height of the global model may be set to, for example, any value between a predetermined range of values (e.g., between 300 to 1000 meters) based on the length and/or other dimensions of a hydraulic fracturing induced fracture and the size of the wellbore. Based on Saint-Venant's Principle of elasticity, stress variation away from the casing's axis in a lateral direction has little impact on the deformation of the casing. Therefore, it is not necessary for the size of the global model to be so large as to encompass the entire length of a hydraulic fracturing induced fracture.

In one or more embodiments, the generated 3D global model may comprise a mesh of 3D finite elements representing different geometries of the subsurface features of the field or formation being modeled. It should be appreciated that any of various 3D finite element modeling tools, including commercially available finite element modeling software programs, may be used to generate the 3D global model. Such a modeling program may include, for example, a library of predefined elements that may be used to model various physical geometries and structures of a rock formation.

In step 504, values of material parameters related to the mechanical properties at different points of the subsurface formation may be calculated based on a geomechanical analysis, e.g., a one-dimensional (1D) geomechanical analysis, of well log data obtained for the subsurface formation, e.g., in the form of micro-seismic data obtained from logs of one or more offset wells drilled along the planned wellbore trajectory, as described above. The material parameters and related mechanical properties may represent, for example and without limitation, a geo-stress distribution, a pore pressure distribution, and a displacement distribution within one or more fractured areas or regions of the 3D global model. The calculated values may then be assigned in step 506 to corresponding points of the 3D global model.

As will be described in further detail below with respect to step 510, the 3D global model including the assigned material parameter values may be used to simulate the hydraulic fracturing effects of one or more injection stages of the hydraulic fracturing treatment on the subsurface formation. In one or more embodiments, at least some of the assigned values may be used to apply various initial conditions and/or boundary conditions to the finite element mesh of the 3D global model for simulation purposes of simulating the mechanical behavior of the formation under hydraulic fracturing injection. Such a simulation may also include, for example, simulating an asymmetrical distribution of fractures that may be generated within the formation during the one or more stages of the hydraulic fracturing treatment along the planned trajectory of the wellbore. As described above, such an asymmetric distribution of hydraulic fracturing induced fractures may reflect the asymmetric distribution of natural fractures within the formation. The distribution of natural fractures within the formation may be characterized by the mechanical properties of the formation and the corresponding values of material parameters assigned to the 3D global model of the formation.

Examples of material parameters relating to the mechanical properties of the formation that may be assigned to the 3D global model include, but are not limited to, bedding plane inclination angles, formation layer thicknesses, fault locations and densities, Young's modulus, Poisson's ratio, etc. In cases where the overburden layers of the formation, e.g., as represented by the top portion of the global model, do not include any porous material, such layers may be modeled as having non-permeable material to further streamline the global model.

In one or more embodiments, steps 504 and 506 may include calculating and assigning values of Young's modulus for points of the formation in areas located on opposite sides of the casing's axis relative to the wellbore trajectory. As described above with respect to FIG. 2B, an area of the formation on one side of the wellbore trajectory and corresponding axis of the casing may have a relatively higher density of fractures than the formation area on the other side of the wellbore trajectory. For the formation area on the side with the higher density of fractures, the value of Young's modulus assigned to each point of the model may vary inversely with injection pressure, e.g., relatively higher injection pressures may produce relatively lower values of Young's modulus. In some embodiments, when a maximum value of injection pressure is reached, the lowest possible value of Young's modulus may be assigned to each point of the global model. The lowest possible value may be, for example, the lowest value within an appropriate range of values corresponding to a set of predetermined hydraulic fracturing injection pressures associated with a particular hydraulic fracturing treatment design. For the formation area on the other side of the well trajectory with a lower density of fractures, the value of Young's modulus may be kept constant, regardless of any changes in the injection pressure.

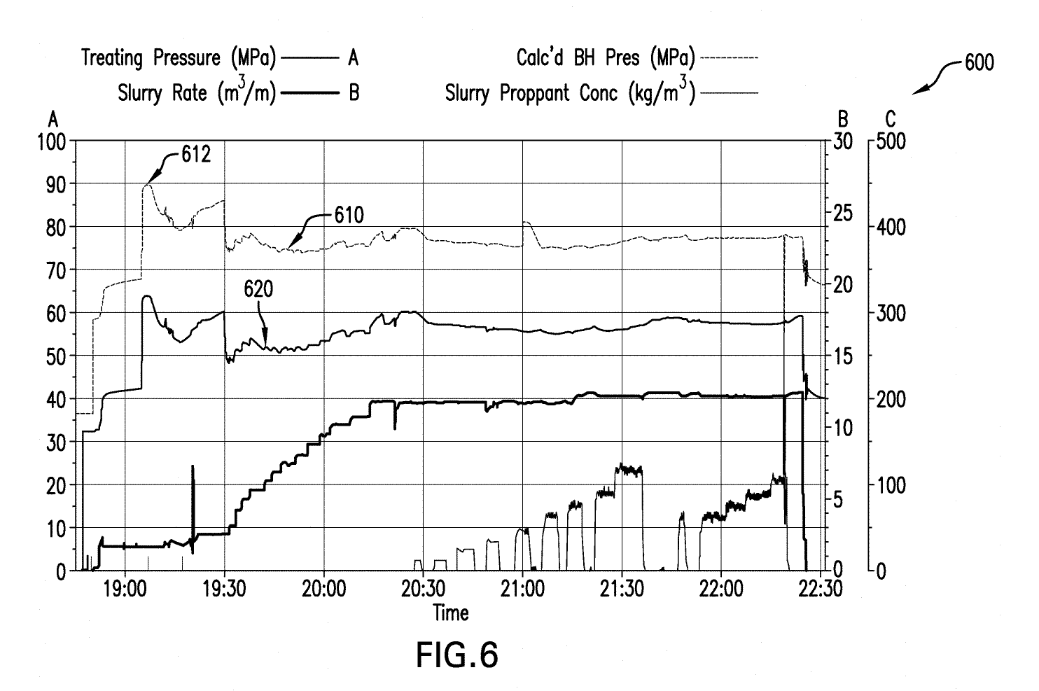

In one or more embodiments, the calculation of Young's modulus may be based on principles of continuum damage mechanics. For example, the geo-mechanical effects associated with the creation and propagation of fracture clouds as a result of hydraulic fracturing may be modeled in a mathematical framework based on continuum damage mechanics. The effects that are modeled may include, for example, the degradation of the subsurface formation's mechanical stiffness during one or more stages of the hydraulic fracturing treatment along the planned wellbore trajectory. As the numerical simulation of damage initiation and evolution at each point of the formation that may be subjected to the hydraulic fracturing treatment may be very time-consuming, the details of the damage initiation and evolution may be ignored in the simulation. Therefore, in some embodiments, a measure of the resultant stiffness degradation of the formation from the variation of Young's modulus with changes in injection pressure, as described above, may be used directly within the 3D global model. Additional details regarding the application of such continuum damage mechanics principles to the 3D global model and simulation will be described further below with respect to FIGS. 6-11B.

In addition to values of Young's modulus, values of Poisson's ratio may be calculated (in step 504) for points of the formation on either side of casing axis and wellbore trajectory and then, assigned (in step 506) to corresponding points of the 3D global model. For the side that has a higher density of fractures, the value of Poisson's ratio at each point of the model may vary with injection pressure. In contrast with the above-described values of Young's modulus, which vary inversely with injection pressure, the values of Poisson's ratio assigned to each point of the global model may vary directly with injection pressure, e.g., relatively higher injection pressures may produce relatively higher values of Poisson's ratio. In some embodiments, when a maximum value of injection pressure is reached, the highest possible value of Poisson's ratio may be assigned to each point. This value may be, for example, the highest value of Poisson's ration within an appropriate range of values corresponding to the set of predetermined hydraulic fracturing injection pressures associated with the particular hydraulic fracturing treatment design in this example. In some implementations, the highest value of Poisson's ration may be limited to a predetermined maximum (e.g., 0.499). For the formation area on the other side of the well trajectory with a lower density of fractures, the value of Poisson's ratio may be kept constant, regardless of any changes in the injection pressure.

The operation of Poisson's ratio on the 3D global model as disclosed herein may be based on, for example, the mechanical definition of Poisson's ratio itself along with data relating to volume expansion observed in the actual formation under hydraulic fracturing injection during a stage of the hydraulic fracturing treatment. Poisson's ratio in this context may represent the transverse deformation coefficient of the formation in this example and may be defined as the negative ratio between the axial strain and the lateral strain without lateral constraints. A relatively higher value of Poisson's ratio may represent a relatively larger volume expansion. Although volume expansion may be primarily due to an increase of pore pressure in the formation, any increase in the value of Poisson's ratio will intensify the amount of volume expansion.

Other material parameters that may be represented in the 3D global model may include, for example, the degradation of the formation's cohesive strength (CS) and internal frictional angle (FA) due to hydraulic fracturing. Values for the CS and FA parameters may be calculated in the same way as described above with respect to Young's modulus, e.g., the value of CS and FA calculated and assigned to points of the 3D global model may decrease as injection pressure increases. Additional details regarding the application of Poisson's ratio along with CS and FA parameters to the 3D global model for simulating the effects of hydraulic fracturing injection on the formation will be described further below with respect to FIGS. 6-11B.

In one or more embodiments, values of pore pressure may be assigned to points of the 3D global model in direct relation to the variation of injection pressure. This may allow the efficiency of the simulation using the 3D global model to be further improved. Also, a coupled poro-elastoplastic model may be applied to the 3D global model to simulate the mechanical behavior of the formation under hydraulic fracturing injection. To represent various hydraulic fracturing injection pressures within fractured formation areas over the multistage hydraulic fracturing treatment as a whole, values of injection pressure assigned to corresponding points of the global model may be selected from a range of pressure values that vary from an initial pore pressure of the formation to a maximum or highest value of injection pressure, e.g., as specified by the particular hydraulic fracturing treatment design.

In one or more embodiments, the 3D global model or material parameters thereof may be calibrated based on measured data obtained during the actual implementation of one or more stages of the hydraulic fracturing treatment design, as described above. The measured data may include, for example and without limitation, values of casing deformation measured downhole (e.g., using downhole sensors in the wellbore) and/or values of measured ground surface deformation (e.g., using seismic equipment located at the surface of the wellbore).

In step 508, a smaller-scale 3D sub-model of a selected portion of the subsurface formation is generated, based on the values assigned to the 3D global model. The selected portion of the subsurface formation may be, for example, a fractured area of the formation surrounding a casing and cementing ring to be placed along the planned trajectory of the wellbore within the subsurface formation. In one or more embodiments, the geometry of 3D sub-model may be based on a finite element mesh generated using a finite element modeling program, as described above. In some implementations, the 3D sub-model may be generated with a relatively higher density finite element mesh than that of the 3D global model in order to further improve the accuracy of the model and numerical results of the simulation based on the model. This may include, for example and without limitation, improving the accuracy of displacement calculations related to the fracture distributions within the selected portion of the formation being modeled. The modeling program may be used, for example, to form the finite element mesh by discretizing the 3D sub-model with tens of thousands of multi-node continuum elements representing material parameters of the casing, cementing ring, and selected portion of the subsurface formation surrounding both. In this way, the 3D sub-model may be generated with a refined mesh that is more accurate and represents more types of materials than that of the related 3D global model.

In one or more embodiments, the bottom surface of the generated 3D sub-model may correspond to a portion of the bottom surface of the 3D global model surrounding the wellbore trajectory. Like the 3D global model, the center of the bottom surface of the 3D sub-model may correspond to the location of the planned trajectory of the horizontal wellbore. In some implementations, only a portion (e.g., upper half) of the casing within the formation is modeled within the 3D sub-model. In this case, it may be assumed that the other portion (e.g., lower half) of the casing that is not modeled is symmetrical to the modeled portion. Thus, it may be assumed for simulation purposes that the deformation behavior of the portion of the casing that is excluded from the model is the same as that of the modeled portion. Also, like the 3D global model, the dimensions of the 3D sub-model may be set to a predetermined range of values that provides an optimal or desired balance between accuracy and efficiency for a particular implementation. In some implementations, the length, width, and height of the 3D sub-model may be set to a predetermined range of values (e.g., from 30 to 100 meters), which is proportionate to that of the 3D global model. However, it should be noted that the disclosed embodiments are not limited thereto and that one or more of the dimensions of the 3D sub-model may have values that are disproportionate to those of the 3D global model. For example, in some implementations, the optimal dimensions of the 3D sub-model may be set to values within a range of 50 to 300 meters.

The values of material parameters assigned to points in a portion of the 3D global model corresponding to the selected portion of the subsurface formation may be reflected in the 3D sub-model. For example, selected points of the 3D sub-model may be assigned values of material parameters assigned (in step 506) to corresponding points in the selected portion of the 3D global model. As the 3D sub-model is also used to model the casing within the formation, additional material parameter values related to the type or quality of the cementing material associated with the casing may also be assigned to the 3D sub-model. For example, the 3D sub-model may include additional points corresponding to the location of a cement ring that surrounds the casing along the planned wellbore trajectory within the selected portion being modeled by the 3D sub-model.

In one or more embodiments, the cementing material parameters of the 3D sub-model may include an elasticity modulus (e.g., Young's modulus) for representing the relative stiffness of the cementing material in different segments of the casing ring that surrounds the casing. As will be described in further detail below, relatively higher values of the elasticity modulus may be assigned to points of the 3D sub-model corresponding to points or segments of the cement ring that are associated with relatively higher quality cementing materials. Thus, the relatively higher values of the elasticity modulus assigned to the 3D sub-model may represent, for example, a greater degree of stiffness of the higher quality cementing material being modeled. The quality of the cementing material may be determined based on, for example, the mechanical properties of the particular type of material used for a particular segment of the cement ring. The mechanical properties for different types of cementing materials may be determined, for example, from various industry standard publications or cementing operation manuals including such information. It should be appreciated that such information may also be available in electronic format, e.g., as stored within a electronic data store accessible via a communication network. Accordingly, the values of cementing material parameters representing the quality of the cementing material in the 3D sub-model may be based on values of the mechanical properties catalogued for different types of cementing materials with such an industry publication.

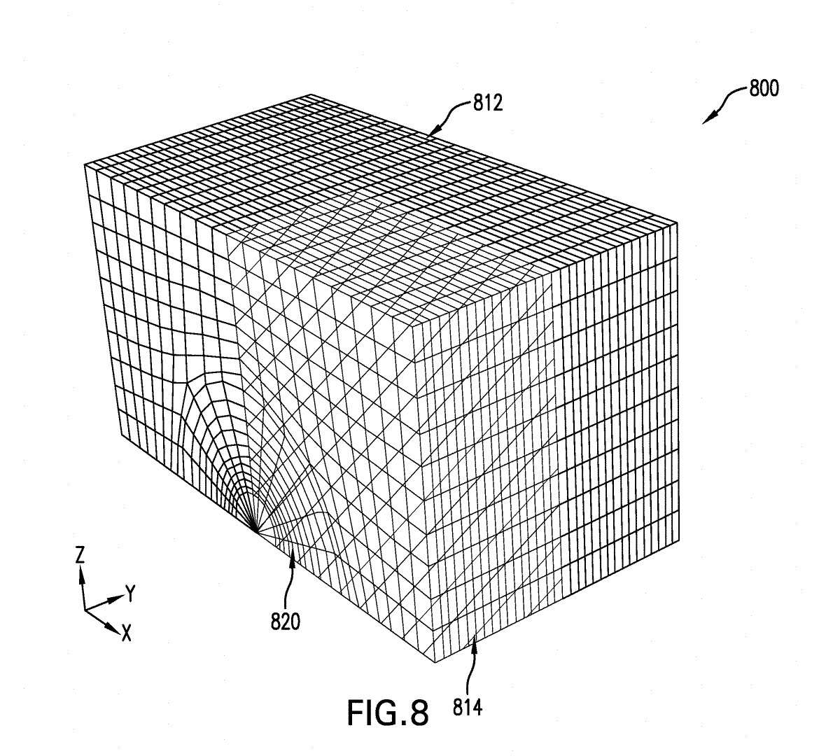

In one or more embodiments, numerical models of continuum damage may be applied to the 3D sub-model to simulate a degradation of the cementing material's stiffness under hydraulic fracturing injection based at least partly on values of the elasticity modulus assigned to points of the 3D sub-model corresponding to the location of the casing ring. In some cases, the same value may be assigned to the cementing material parameter of the 3D sub-model regardless of the quality of the cementing material associated with the casing. For example, a relatively higher value may be assigned to simulate the mechanical behavior of the casing in the 3D sub-model when the cementing material quality is relatively high. Conversely, a relatively lower value may be assigned to simulate the mechanical behavior of the casing in the 3D sub-model when the cementing material quality is relatively low. Additional details regarding the simulation of different cementing material quality using the 3D global model will be described further below with respect to FIGS. 8-11B.

To simulate the mechanical behavior of the subsurface formation under hydraulic fracturing injection loads using the 3D global model, process 500 proceeds to step 510. In step 510, one or more numerical damage models are applied to the 3D global model to simulate the hydraulic fracturing effects of one or more stages of the multistage hydraulic fracturing treatment on the subsurface formation. In one or more embodiments, the numerical damage models applied to the 3D global model may include, for example and without limitation, a plasticity-based continuum damage model and a coupled poro-elastoplastic finite element model. Such continuum damage models may be used, for example, to stimulate the hydraulic fracturing effects at a material level of the subsurface formation or targeted portion thereof. For example, the coupled poro-elastoplastic finite element model may be applied to the 3D global model to simulate the mechanical behavior of the formation under various hydraulic fracturing injection loads and boundary conditions at a structural level. The simulation in step 510 may include, for example, calculating numerical values of deformation within the 3D global model along with values for a displacement field of the 3D global model for each of a plurality of hydraulic fracturing injection pressures.

In one or more embodiments, the values calculated based on the simulation using the 3D global model may be used to specify initial conditions and/or boundary conditions for a simulation to be performed in step 512 using the 3D sub-model. In step 512, the above-described numerical damage models may be applied to the 3D sub-model to simulate the hydraulic fracturing effects of the one or more stages of the multistage hydraulic fracturing treatment on the casing located along the planned trajectory of the wellbore. The simulation using the 3D sub-model may be based on, for example, the simulation performed in step 510 using the 3D global model, as described above.

The results of the simulation performed in step 512 using the 3D sub-model may then be used in step 514 to estimate at least one value of casing deformation expected to occur at a location along the planned trajectory of the wellbore. The casing deformation value estimated for the particular location along the wellbore trajectory in this example may indicate that significant casing deformation is expected to occur at that location. Casing deformation may be deemed significant if, for example, the estimated value(s) are above a predetermined threshold. In one or more embodiments, the value of casing deformation may be estimated for each of a plurality of fluid injection pressures associated with the one or more stages of the multistage hydraulic fracturing treatment. In some implementations, each stage of the hydraulic fracturing treatment may be performed along a different section of the wellbore. Accordingly, the value of casing deformation may be estimated for the one or more sections of the wellbore that correspond to the one or more stages of the hydraulic fracturing treatment.

In one or more embodiments, the value of casing deformation estimated in step 514 may be a maximum value of lateral displacement estimated for the casing associated with each of the section of the wellbore along the planned trajectory of the horizontal wellbore within the subsurface formation. Additionally or alternatively, the value estimated in step 514 may be a maximum value of vertical displacement estimated for the casing associated with each of the one or more sections of the wellbore along the planned trajectory of the horizontal wellbore within the subsurface formation.

In one or more embodiments, the above-described value(s) of casing deformation estimated in step 514 may be used to determine or adjust one or more design parameters for stages of the multi stage hydraulic fracturing treatment to be performed along the planned trajectory of the wellbore. Such design parameters may include, for example and without limitation, a maximum fluid injection pressure for each of these different stages of the multistage hydraulic fracturing treatment. As described above, such a maximum injection pressure may be a maximum threshold value of safe hydraulic fracturing fluid injection pressures that can be used during each stage of the treatment without causing significant casing deformation along the wellbore, e.g., either in a section of the wellbore corresponding to that particular treatment stage or any other sections of the wellbore corresponding to later stages of the hydraulic fracturing treatment to be performed. Such a maximum safe injection pressure threshold may enable the design of the multistage hydraulic fracturing treatment to be optimized by helping to maintain casing integrity along the wellbore trajectory for different stages of the hydraulic fracturing treatment. Other design parameters that may be adjusted to improve the hydraulic fracturing treatment design based on the estimated casing deformation may include, but are not limited to, the type of casing or quality of the cementing material used for the casing in a particular section of the wellbore associated with the estimated location of casing deformation.

As the above-described 3D numerical models are streamlined so as to model only the most important or essential mechanical characteristics impacting casing deformation under hydraulic fracturing injection, the use of such models may significantly reduce the computation burden associated with simulating the hydraulic fracturing effects on the formation and the casing for different stages of the hydraulic fracturing treatment. As the interaction between the formation, cementing material, and the casing are simulated in a fully coupled way, the computational efficiency of the 3D models and casing deformation estimation techniques disclosed herein allow system performance to be improved without sacrificing numerical accuracy.

In some implementations, the accuracy of the simulation may be further improved by generating a second 3D sub-model from the initial or first 3D sub-model generated in step 508 and described above. Such a second 3D sub-model may be, for example, a refined version of the first 3D sub-model that is generated using modeling techniques similar to those used to generate the first 3D sub-model from the 3D global model as described above. For example, the second 3D sub-model may be generated with a relatively higher density finite element mesh than that of the first 3D sub-model. To reduce the additional computational burden that may be associated with such a higher density mesh, the second 3D sub-model may be generated at a smaller scale relative to the first 3D sub-model. Thus, the second 3D sub-model may represent only a portion of first 3D sub-model and sub-portion of the selected portion of the subsurface formation represented by the first 3D sub-model. In one or more embodiments, the one or more numerical damage models applied to the first 3D sub-model may also be applied (in step 512) to the second or refined 3D sub-model, where the results of the simulation using the first 3D sub-model may be used to determine initial and/or boundary conditions for the simulation using the second/refined 3D sub-model. The simulation using the refined 3D sub-model may then be used (in step 514) to estimate at least one refined value of casing deformation, which may provide a more accurate estimation of casing deformation along the planned wellbore trajectory than the previously estimated value.

To help further describe embodiments of the present disclosure, FIGS. 6-11B will be used to provide an example of a practical application of the 3D modeling and casing deformation estimation techniques described above with respect to process 500 of FIG. 5. For purposes of the following example, it will be assumed that the multistage hydraulic fracturing treatment design has ten stages of hydraulic fracturing injection to stimulate hydrocarbon production from the targeted subsurface formation along a planned trajectory of a horizontal wellbore through the formation. It will also be assumed for purposes of this example that casing deformation may occur at any of these stages (e.g., during the third stage) of the hydraulic fracturing treatment operation. While the following example will be described using data values that may be representative of casing deformation that can occur during an actual hydraulic fracturing injection treatment, it should be noted that such values are provided for illustrative purposes only and that the disclosed embodiments are not intended to be limited thereto.

An example of the injection pressures that may be recorded during such a stage of the hydraulic fracturing treatment in which casing deformation occurs is shown in FIG. 6. In FIG. 6, a graph 600 shows a bottom hole pressure curve 610 and a pressure curve 620 representing the hydraulic fracturing injection pressure at ground surface during the hydraulic fracturing treatment stage in question. A point 612 along pressure curve 610 corresponds to the injection pressure when casing deformation occurs along the wellbore during the hydraulic fracturing treatment stage.

As will be described in further detail below, the casing deformation in this example may be estimated based on 3D models and simulations of the hydraulic fracturing effects on the formation and the casing during this stage of the hydraulic fracturing treatment. The 3D models in this example may be defined by the following set of input parameters: (1) an initial geo-stress field; (2) casing parameters; (3) cementing parameters; (4) mechanical properties of the rock formations; (5) an injection pressure; and (6) an initial pore pressure. As described above and as will be described in further detail below, the 3D models may include a 3D global model of the formation and a 3D sub-model of a selected portion of the formation including the casing along the planned wellbore trajectory within the formation. As the casing is modeled in the 3D sub-model only and input parameters (2) and (3) relate to the casing and cementing specifically, it should be noted that these parameters apply only to the 3D sub-model while the remaining parameters apply to both the 3D global model as well as the 3D sub-model.

The initial geo-stress field may be defined by a set of geo-stress parameters relating to the sequence and direction of principal stress within the subsurface formation. For purposes of this example, it is assumed that the initial geo-stress field of the formation is defined by the following geo-stress parameters and corresponding values: a vertical stress (denoted “Sig_v”) set to 63 MPa; a minimum horizontal principal stress (“Sh”) set to 66.2 MPa; and a maximum horizontal principal stress (“SH”) set to 66.6 MPa. The direction of the maximum horizontal principal stress is assumed to be parallel to the wellbore axis.

The casing parameters may include geometric parameters and material parameters associated with the casing to be inserted along a planned trajectory of the wellbore in this example. Such casing parameters may include, for example and without limitation, an inner diameter of the casing, a casing thickness, a material density of the material (e.g., a P110 grade steel) used to construct the casing, an initial yielding strength of the casing, a modulus of elasticity, a modulus of shearing, and Poisson's ratio. It is assumed that the values of the casing parameters in this example are as follows: the inner diameter of the casing is 0.1214 meters; the casing thickness is 0.0091494 meters; the material density of the cementing material is 7922 kg/m3; the initial yielding strength is 758 MPa; the modulus of elasticity (E) or Young's modulus is 206 GPa; the modulus of shearing (G) is 79.38 GPa; and the Poisson's ratio is 0.3. In some implementations, an elastoplastic model may be applied to simulate plastic deformation of the cementing material.

The cementing parameters may include a set of parameters related to the geometry and cementing material associated with the cement ring or sheath to be placed around the casing within the wellbore. The following cementing parameters and values are assumed for the cement sheath in this example: an inner diameter of the cement sheath is 0.1397 meters; an outer diameter of the sheath is 0.2159 meters; a material density is 1900 kg/m3; the modulus of elasticity (E) of regular cementing material is 27.2 GPa; and the Poisson's ratio is 0.3.

The mechanical properties of the rock formations defined in the 3D models may include, for example, a rock density of 2650 kg/m3, a modulus of elasticity (E) or Young's modulus of 40 GPa, and an initial value of Poisson's ratio set to 0.25. In addition, a maximum value of Young's modulus related to the stiffness and degradation of the formation around the wellbore may be set to 30%. The stiffness of the formation in areas with a relatively high fracture density may be lower than other areas of the formation. Accordingly, the value of Young's modulus for an area of the formation with a relatively high density of fractures on one side of the wellbore trajectory may be set to 70% of the value set for the formation area with a relatively low fracture density on an opposite side of the wellbore trajectory.

The bottom-hole injection pressure of the fracturing process in this example may be calculated from pumping pressure with the assumption that there is no fluid friction drag. The peak value of fluid pressure (P) applied on the inner surface of the casing is assumed to be 90 MPa. Also, it is assumed that values of injection pressure are assigned to the fractured formation as its pore pressure in the process of hydraulic fracturing injection. Areas of the formation that are not successfully fractured are assumed to keep their original values of pore pressure. The initial pore pressure of the formation is assumed to be 30 MPa.

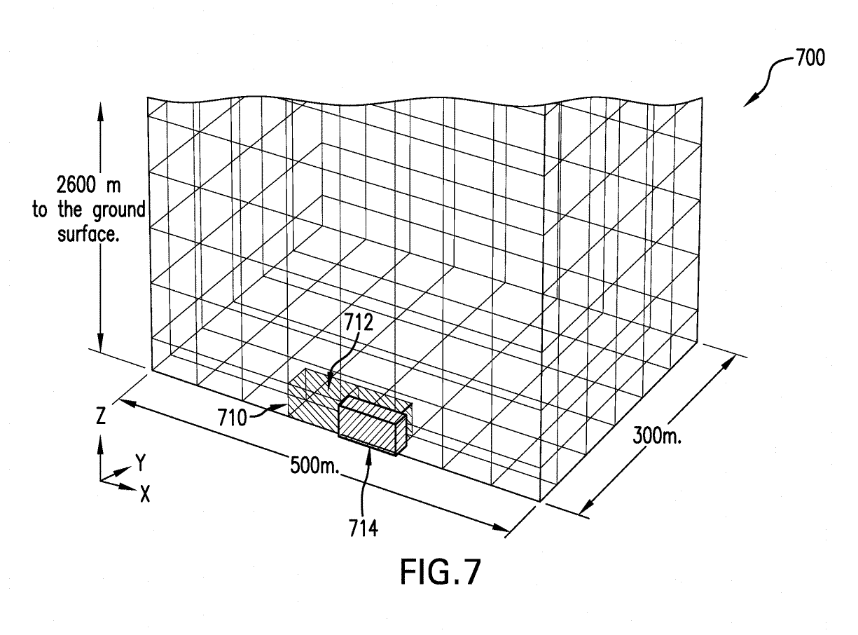

FIG. 7 is a diagram of an illustrative 3D global model 700 of the subsurface formation in this example. As shown in FIG. 7, the 3D global model 700 may be, for example, a 3D finite element model with its dimensions defined along XYZ coordinate directions within 3D space. For purposes of this example, it is assumed that the 3D global model 700 has a length of 500 meters extending in the X direction, a width of 300 meters in the Y direction, and a height of 2600 meters in the Z direction. The height of the 3D global model 700 in this example is defined by the true vertical depth (TVD) of the casing within the formation, which is assumed to be 2600 meters from the surface of the formation. It is further assumed that the following boundary conditions are defined for the 3D global model 700: a zero displacement constraint is applied in a direction that is normal to the bottom surface and each of the lateral surfaces of the 3D global model 700. A top surface of 3D global model, which represents the ground surface of the formation, is assumed to be free of any load and displacement constraints.

As described above, the calculated values of material parameters related to the mechanical properties of different points of the subsurface formation may be assigned to corresponding points of the 3D global model 700. The assigned values may then be used to generate a smaller scale 3D sub-model corresponding to a selected portion of the subsurface formation, as will be described in further detail below with respect to FIG. 8. The selected portion may correspond to a fractured area of the formation surrounding the casing along the planned wellbore trajectory, as represented by a portion 710 of the 3D global model 700 in FIG. 7.

In this example, a central axis of the casing and planned trajectory of the wellbore are represented at the center of the bottom surface of 3D global model 700. The trajectory of the wellbore and casing the 3D global model 700 and the 3D sub-model of FIG. 8 are assumed to be in the Y-direction while the direction in which natural and hydraulic fracturing induced fractures propagate is assumed to be in the X-direction. The X-direction is therefore assumed to be the direction of maximum horizontal stress. To simulate the unevenness of the fracture distribution within the formation, areas 712 and 714 of the selected portion 710 as shown in FIG. 7 may be assigned different elasticity modulus values. In this example, area 712 may represent a formation area on one side of the casing axis and planned wellbore trajectory with a relatively low density of natural fractures whereas area 714 may represent a formation area on the opposite side of the casing axis and wellbore trajectory with a relatively high density of natural fractures.

FIG. 8 is a diagram of an illustrative 3D sub-model 800 of a selected portion of the subsurface formation corresponding to portion 710 of the 3D global model 700 of FIG. 7. The 3D sub-model 800 may be generated using various sub-modeling techniques that accommodate for the discrepancy in scale between the two models. Such techniques also may be used to derive appropriate boundary conditions for the smaller scale 3D sub-model 800 from the larger scale 3D global model 700. Like the 3D global model 700, the 3D sub-model 800 may be a 3D FEM model. However, the mesh density of the 3D sub-model 800 may be further increased to improve the accuracy of displacement calculations related to the fracture distributions within the selected portion of the formation. While not shown in FIG. 8, a second or refined version of the 3D sub-model 800 may be generated using modeling techniques similar to those used to generate 3D sub-model 800 from the 3D sub-model 700 of FIG. 7. Such a refined 3D sub-model may be, for example, a version of 3D sub-model 800 that is generated with a higher mesh density to further improve accuracy but at a smaller scale to maintain computational efficiency, e.g., within acceptable limits. For example, such a smaller-scale refined 3D sub-model may correspond to a portion of the 3D sub-model 800 that has a similar shape with smaller dimensions in proportion to the 3D sub-model 800.

As shown in FIG. 8, the 3D sub-model 800 includes areas 812 and 814 corresponding to areas 712 and 714, respectively, of the 3D global model 700 of FIG. 7, as described above. Area 814 of the formation may represent a high fracture density area of the selected portion of the formation corresponding to a fraction (e.g., one quarter) of the model's geometry. The casing and cement ring around the casing are represented in an area 820 of the 3D sub-model 800.

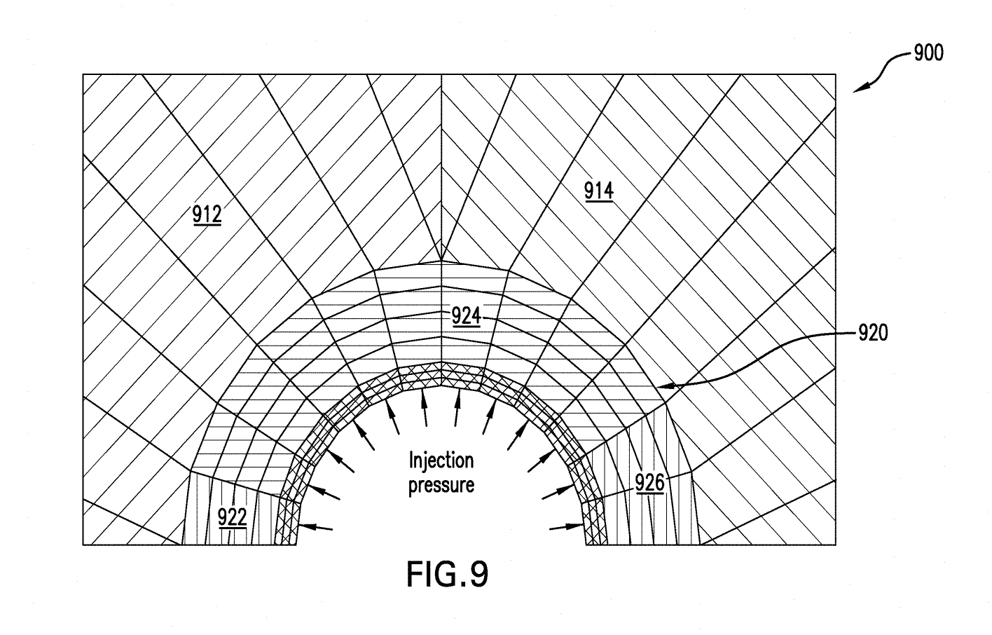

FIG. 9 is a diagram showing a cross-sectional view 900 of the 3D sub-model 800 including the casing and cement area 820 of FIG. 8. As shown in FIG. 9, the cross-sectional view 900 includes low and high fracture density formation areas 912 and 914 corresponding to areas 812 and 814 of the 3D sub-model 800, respectively. Also, as shown in FIG. 9, a cement ring 920 includes has been divided into different segments based on the quality of the cementing material used in each segment. For example, segments 922 and 926 may represent parts of the cementing ring 920 in which relatively high-quality cementing material was used. However, a segment 924 of the cementing ring 920 may represent a relatively weaker part of the cementing ring 920 in which low-quality cementing material was used or poor quality cementing work was performed.

To simulate an unevenness of the cement sheath filling caused by poor quality cementing material or well cementation work, the cementing material parameters (e.g., Young's modulus) for each of segments 922 and 926 in the 3D sub-model may be assigned a default value representing cementing material of good or acceptable quality while the cementing material parameters for segment 924 may be assigned a relatively lower value. The cementing material parameters in segment 924 may also be assigned a relatively lower value due to imperfections (e.g., air bubbles) within the cementing material. For example, such poor quality cementing material can be assigned a value of zero or one that is 10% of the default value assigned to the acceptable or good-quality cementing material of segments 922 and 926 of the cementing ring 920. Thus, if the value of Young's modulus assigned to each of segments 922 and 926 in this example is 27.2 GPa, the value assigned to segment 924 may be 2.72 GPa.

It should be appreciated that the disclosed embodiments are not intended to be limited to only two types of quality and that parameter values representing a range of quality, e.g., between very good and very poor, may also be used as desired for a particular implementation. The size of each segment or percentage of the cementing ring 920 covered by each segment may vary based on, for example, a measured or predetermined quality index associated with the cementing material within each segment.

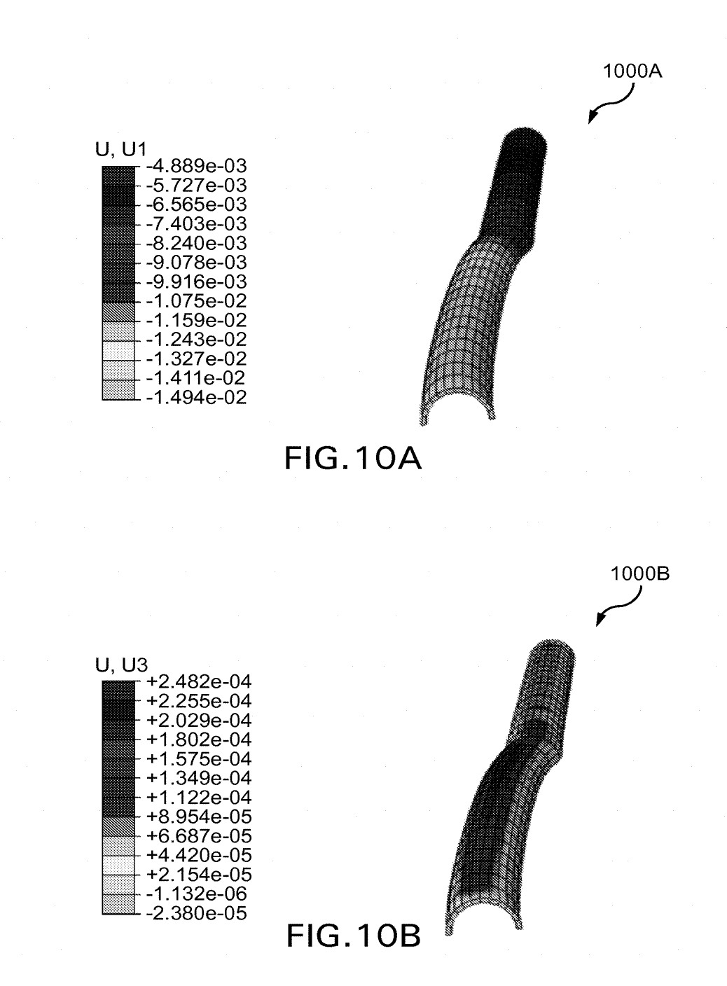

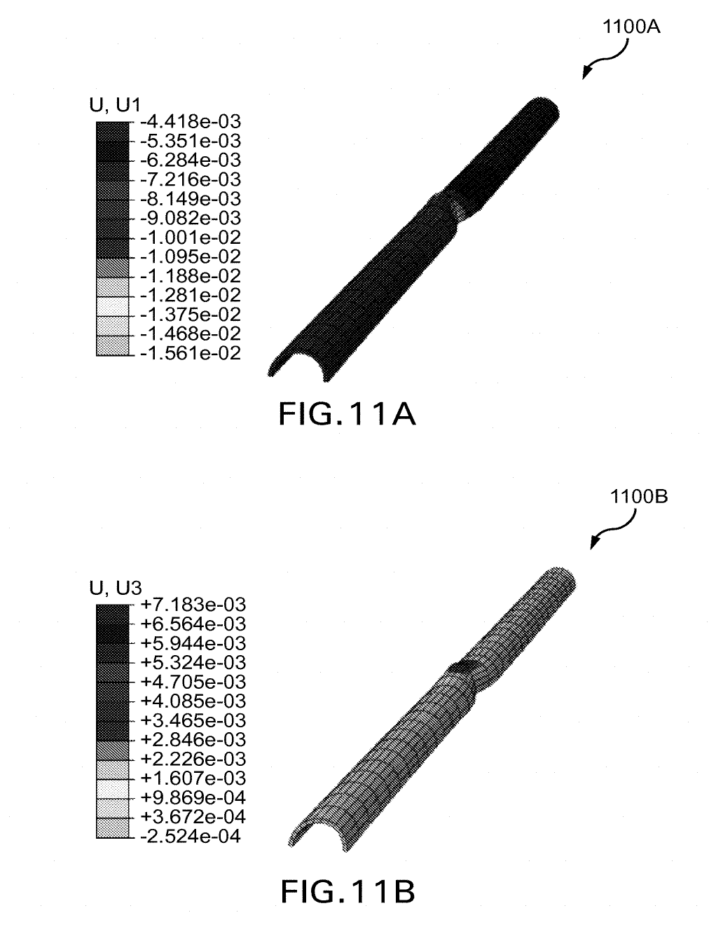

Once the material parameter values have been assigned to the 3D global model 700 of FIG. 7 and the 3D sub-model 800 of FIG. 8 as described above, one or more numerical damage models can be applied to the 3D global model 700 and the 3D sub-model 800 to simulate the hydraulic fracturing effects of one or more stages of the multistage hydraulic fracturing treatment on the subsurface formation and the casing along the planned wellbore trajectory therein. As described above, the results of the simulation using the 3D global model 700 are used as boundary conditions for the simulation using the 3D sub-model 800. The results of the simulation using the 3D sub-model 800 may then be used to estimate casing deformation along the wellbore trajectory, as shown in FIGS. 10A-11B.

FIGS. 10A and 10B are 3D meshes illustrating estimated values of casing deformation with relatively high quality cementing material along the horizontal wellbore. In FIG. 10A, a 3D mesh 1000A illustrates casing deformation in a lateral direction relative to the horizontal wellbore trajectory. In FIG. 10B, a 3D mesh 1000B illustrates casing deformation in a vertical direction relative to the horizontal wellbore trajectory. The values shown alongside 3D mesh 1000A in FIG. 10A may represent, for example, the maximum amount of lateral displacement estimated for the casing along the wellbore trajectory during one or more stages of the simulated hydraulic fracturing injection treatment in this example. Similarly, the values shown alongside 3D mesh 1000B in FIG. 10B may represent the maximum amount of vertical displacement estimated for the casing along the wellbore trajectory during the simulated hydraulic fracturing injection treatment stage(s).

FIGS. 11A and 11B are 3D meshes illustrating estimated values of casing deformation with relatively low quality cementing material along the horizontal wellbore. In FIG. 11A, a 3D mesh 1100A illustrates casing deformation in a lateral direction relative to a horizontal wellbore trajectory. In FIG. 11B, a 3D mesh 1100B illustrates casing deformation in a vertical direction relative to the horizontal wellbore trajectory. Similar to FIGS. 10A and 10B, the values listed alongside 3D mesh 1100A and 3D mesh 1100B may represent the maximum amount of lateral and vertical displacement, respectively, estimated for the casing along the wellbore trajectory during one or more stages of the simulated hydraulic fracturing injection treatment as described above. In some implementations, a predetermined maximum threshold displacement value may be used to determine whether or not any of the maximum lateral displacement and/or vertical displacement values estimated for the casing represent a significant or an unacceptable level of casing deformation.

A comparison between the lateral displacement values (“U1”) shown alongside 3D meshes 1000A and 1100A in FIGS. 10A and 11A, respectively, reveal that the estimated casing deformation expected to occur in the lateral direction is similar for both high-quality and low-quality cementing materials. However, a comparison of the vertical displacement values (“U3”) shown alongside 3D meshes 1000B and 1100B in FIGS. 10B and 11B, respectively, reveal that the estimated vertical casing deformation expected to occur with low quality cementing material is significantly larger than with high quality cementing material. This comparison therefore shows that the quality of the cementing material may be a significant factor that can intensify the amount of vertical casing deformation during hydraulic fracturing injection treatments along the wellbore.

Table 1 below further shows maximum values of the von Mises equivalent stress estimated for the casing under different hydraulic fracturing injection pressures, e.g., based on the simulation using the 3D sub-model 800, as described above with respect to FIGS. 8 and 9:

TABLE 1

| | Maximum value of | | Distribution of Asymmetric | |
|---|---|---|---|---|
| Injection | casing deformation/ | | Properties | |
| Pressure/ | mm | | | Cement ring |
| MPa | lateral | vertical | Fractures | quality |
| 90 | 15.6 | 7.18 | Asymmetric | poor |
| 90 | 14.9 | 0.2 | Asymmetric | |
| 80 | 9.5 | 0.83 | Asymmetric | poor |
| 80 | 5.7 | 0.34 | Asymmetric | |

Each maximum value of casing deformation listed in each row of Table 1 above represents the maximum value of either lateral or vertical displacement estimated for the casing under a particular hydraulic fracturing injection pressure. It may be assumed that 90 MPa is the peak value of hydraulic fracturing injection pressure in this example. The following observations may be made based on the values shown in Table 1: (1) when the value of injection pressure is equivalent to the 90 MPa peak value, the quality of the cementing material associated with the cement ring may have a large impact on the amount of vertical displacement that can occur, but only a small impact on the amount of lateral displacement; (2) when the injection pressure is decreased to a value of 80 MPa, the amount of displacement in both lateral and vertical directions is significantly lower than when the injection pressure is at its peak value; and (3) 80 MPa may be a safe value for the maximum injection pressure that can be used without causing significant casing deformation and that can be used as the maximum injection pressure threshold to maintain casing integrity during the hydraulic fracturing injection treatment in this example.

As noted previously, the major factors contributing to the occurrence of significant casing deformation during hydraulic fracturing injection stimulation operations include: (1) high values of injection pressure; (2) an asymmetric distribution natural and/or induced fractures within the surrounding formation; and (3) the quality of the cement ring around the casing, including the quality of the cementing material and whether or not that material was uniformly distributed around the casing when the ring was formed. While hydraulic fracturing injection pressure may be the leading factor, Table 1 shows that cementing quality may be the primary factor that impacts the amount or intensity of any casing deformation that occurs as a result of high hydraulic fracturing injection pressures.

As described above, the casing deformation values estimated based on the simulation in this example may be used to determine or adjust one or more hydraulic fracturing treatment design parameters including, but not limited to, a maximum fluid injection pressure for each stage of the multistage hydraulic fracturing treatment and a quality of the cementing material used for the casing along each treatment stage. Also, as described above, the disclosed modeling and casing deformation estimation techniques enable the interaction between the formation and the casing to be simulated in a fully coupled way. Therefore, advantages of the disclosed techniques include, but are not limited to, providing a computationally efficient way to estimate casing deformation that allows system performance to be improved without sacrificing numerical accuracy.

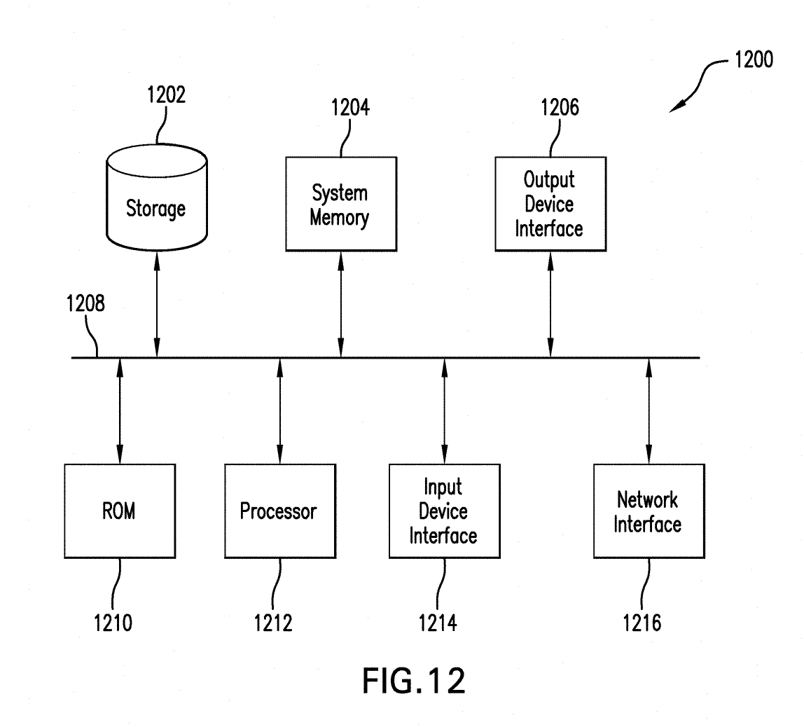

FIG. 12 is a block diagram of an exemplary computer system 1200 in which embodiments of the present disclosure may be implemented. For example, the steps of process 500 of FIG. 5, as described above, may be implemented using system 1200. System 1200 can be a computer, phone, PDA, or any other type of electronic device. Such an electronic device includes various types of computer readable media and interfaces for various other types of computer readable media. As shown in FIG. 12, system 1200 includes a permanent storage device 1202, a system memory 1204, an output device interface 1206, a system communications bus 1208, a read-only memory (ROM) 1210, processing unit(s) 1212, an input device interface 1214, and a network interface 1216.

Bus 1208 collectively represents all system, peripheral, and chipset buses that communicatively connect the numerous internal devices of system 1200. For instance, bus 1208 communicatively connects processing unit(s) 1212 with ROM 1210, system memory 1204, and permanent storage device 1202.

From these various memory units, processing unit(s) 1212 retrieves instructions to execute and data to process in order to execute the processes of the subject disclosure. The processing unit(s) can be a single processor or a multi-core processor in different implementations.

ROM 1210 stores static data and instructions that are needed by processing unit(s) 1212 and other modules of system 1200. Permanent storage device 1202, on the other hand, is a read-and-write memory device. This device is a non-volatile memory unit that stores instructions and data even when system 1200 is off. Some implementations of the subject disclosure use a mass-storage device (such as a magnetic or optical disk and its corresponding disk drive) as permanent storage device 1202.

Other implementations use a removable storage device (such as a floppy disk, flash drive, and its corresponding disk drive) as permanent storage device 1202. Like permanent storage device 1202, system memory 1204 is a read-and-write memory device. However, unlike storage device 1202, system memory 1204 is a volatile read-and-write memory, such a random access memory. System memory 1204 stores some of the instructions and data that the processor needs at runtime. In some implementations, the processes of the subject disclosure are stored in system memory 1204, permanent storage device 1202, and/or ROM 1210. For example, the various memory units include instructions for computer aided pipe string design based on existing string designs in accordance with some implementations. From these various memory units, processing unit(s) 1212 retrieves instructions to execute and data to process in order to execute the processes of some implementations.

Bus 1208 also connects to input and output device interfaces 1214 and 1206. Input device interface 1214 enables the user to communicate information and select commands to the system 1200. Input devices used with input device interface 1214 include, for example, alphanumeric, QWERTY, or T9 keyboards, microphones, and pointing devices (also called “cursor control devices”). Output device interfaces 1206 enables, for example, the display of images generated by the system 1200. Output devices used with output device interface 1206 include, for example, printers and display devices, such as cathode ray tubes (CRT) or liquid crystal displays (LCD). Some implementations include devices such as a touchscreen that functions as both input and output devices. It should be appreciated that embodiments of the present disclosure may be implemented using a computer including any of various types of input and output devices for enabling interaction with a user. Such interaction may include feedback to or from the user in different forms of sensory feedback including, but not limited to, visual feedback, auditory feedback, or tactile feedback. Further, input from the user can be received in any form including, but not limited to, acoustic, speech, or tactile input. Additionally, interaction with the user may include transmitting and receiving different types of information, e.g., in the form of documents, to and from the user via the above-described interfaces.

Also, as shown in FIG. 12, bus 1208 also couples system 1200 to a public or private network (not shown) or combination of networks through a network interface 1216. Such a network may include, for example, a local area network (“LAN”), such as an Intranet, or a wide area network (“WAN”), such as the Internet. Any or all components of system 1200 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself. Accordingly, the steps of process 500 of FIG. 5, as described above, may be implemented using system 1200 or any computer system having processing circuitry or a computer program product including instructions stored therein, which, when executed by at least one processor, causes the processor to perform functions relating to these methods.

As used in this specification and any claims of this application, the terms “computer”, “server”, “processor”, and “memory” all refer to electronic or other technological devices. These terms exclude people or groups of people. As used herein, the terms “computer readable medium” and “computer readable media” refer generally to tangible, physical, and non-transitory electronic storage mediums that store information in a form that is readable by a computer.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., a web page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of exemplary approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Furthermore, the exemplary methodologies described herein may be implemented by a system including processing circuitry or a computer program product including instructions which, when executed by at least one processor, causes the processor to perform any of the methodology described herein.

As described above, embodiments of the present disclosure are particularly useful for modeling casing deformation for hydraulic fracturing design. Accordingly, advantages of the present disclosure include using fully coupled modeling techniques to provide a computationally efficient workflow for estimating casing deformation that allows system performance to be improved without sacrificing numerical accuracy.

In one embodiment of the present disclosure, a computer-implemented method of modeling casing deformation for hydraulic fracturing design includes: generating a three-dimensional (3D) global model of a subsurface formation targeted for a multistage hydraulic fracturing treatment to be performed along a planned trajectory of a wellbore within the subsurface formation; calculating values of material parameters for different points of the subsurface formation represented by the 3D global model, based on a geomechanical analysis of well log data obtained for the subsurface formation; assigning the calculated values to corresponding points of the 3D global model; generating a 3D sub-model of a selected portion of the subsurface formation including a casing to be placed along the planned trajectory of the wellbore within the subsurface formation, based at least partly on the values assigned to the 3D global model; applying one or more numerical damage models to the 3D global model to simulate hydraulic fracturing effects of one or more stages of the multistage hydraulic fracturing treatment on the subsurface formation; applying the one or more numerical damage models to the 3D sub-model to simulate the hydraulic fracturing effects of the one or more stages of the multistage hydraulic fracturing treatment on the casing along the planned trajectory of the wellbore within the subsurface formation, based on the simulation using the 3D global model; and estimating at least one value of casing deformation along the planned trajectory of the wellbore, based on the simulation using the 3D sub-model. Further, a computer-readable storage medium with instructions stored therein has been described, where the instructions when executed by a computer cause the computer to perform a plurality of functions, including functions to: generate a three-dimensional (3D) global model of a subsurface formation targeted for a multistage hydraulic fracturing treatment to be performed along a planned trajectory of a wellbore within the subsurface formation; calculate values of material parameters for different points of the subsurface formation represented by the 3D global model, based on a geomechanical analysis of well log data obtained for the subsurface formation; assign the calculated values to corresponding points of the 3D global model; generate a 3D sub-model of a selected portion of the subsurface formation including a casing to be placed along the planned trajectory of the wellbore within the subsurface formation, based at least partly on the values assigned to the 3D global model; apply one or more numerical damage models to the 3D global model to simulate hydraulic fracturing effects of one or more stages of the multistage hydraulic fracturing treatment on the subsurface formation; apply the one or more numerical damage models to the 3D sub-model to simulate the hydraulic fracturing effects of the one or more stages of the multistage hydraulic fracturing treatment on the casing along the planned trajectory of the wellbore within the subsurface formation, based on the simulation using the 3D global model; and estimate at least one value of casing deformation along the planned trajectory of the wellbore, based on the simulation using the 3D sub-model.

For the foregoing embodiments, the value of casing deformation may be estimated for one or more sections of the wellbore that correspond to the one or more stages of the multistage hydraulic fracturing treatment and/or each of a plurality of fluid injection pressures associated with the one or more stages of the multistage hydraulic fracturing treatment. The wellbore may be a horizontal wellbore, and the estimated value of casing deformation may be a maximum value of at least one of a lateral displacement or a vertical displacement estimated for the casing associated with each of the one or more sections along the planned trajectory of the horizontal wellbore within the subsurface formation. The one or more numerical damage models may be applied to each of the 3D global model and the 3D sub-model to simulate an asymmetrical distribution of fractures generated by the one or more stages of the multistage hydraulic fracturing treatment within the subsurface formation. The material parameters may include an elasticity modulus, and the asymmetrical distribution of fractures may be simulated by varying values of the elasticity modulus assigned to the different points of the subsurface formation corresponding to the selected portion modeled by the 3D sub-model. Such different points may include: a first set of points corresponding to a first area of the selected portion on one side of the planned trajectory of the wellbore having a relatively low density of natural fractures; a second set of points corresponding to a second area of the selected portion on another side of the planned trajectory of the wellbore having a relatively high density of natural fractures; and a third set of points corresponding to a location of a cement ring surrounding the casing. The values of the elasticity modulus assigned to points of the 3D sub-model corresponding to the second set of points may be relatively lower than those assigned to points of the 3D sub-model corresponding to the first set of points. The values of the elasticity modulus assigned to points of the 3D sub-model corresponding to the third set of points may be based on a quality of cementing material associated with different segments of the cement ring. The one or more numerical damage models may be applied to the 3D sub-model to simulate a stiffness degradation of the cementing material associated with one or more of the different segments of the cement ring based on the values of the elasticity modulus assigned to corresponding points of the 3D sub-model.

Further, the foregoing embodiments may include any one of the following functions, operations or elements, alone or in combination with each other: generating a refined version of the 3D sub-model based on the simulated stiffness degradation of the cementing material; applying the one or more numerical damage models to the refined version of the 3D sub-model to simulate the stiffness degradation of the cementing material; and estimating at least one refined value of casing deformation along the planned trajectory of the wellbore, based on the simulation using the refined version of the 3D sub-model. Further, such embodiments may include determining one or more design parameters for each stage of the multistage hydraulic fracturing treatment to be performed along the planned trajectory of the wellbore, based on the estimated value of casing deformation. The one or more design parameters may include one or more of a maximum fluid injection pressure for each stage of the multistage hydraulic fracturing treatment and a quality of cementing material associated with the casing within one or more sections of the wellbore along the planned trajectory.

Likewise, a system has been described, which includes at least one processor and a memory coupled to the processor that has instructions stored therein, which when executed by the processor, cause the processor to perform functions, including functions to: generate a three-dimensional (3D) global model of a subsurface formation targeted for a multistage hydraulic fracturing treatment to be performed along a planned trajectory of a wellbore within the subsurface formation; calculate values of material parameters for different points of the subsurface formation represented by the 3D global model, based on a geomechanical analysis of well log data obtained for the subsurface formation; assign the calculated values to corresponding points of the 3D global model; generate a 3D sub-model of a selected portion of the subsurface formation including a casing to be placed along the planned trajectory of the wellbore within the subsurface formation, based at least partly on the values assigned to the 3D global model; apply one or more numerical damage models to the 3D global model to simulate hydraulic fracturing effects of one or more stages of the multistage hydraulic fracturing treatment on the subsurface formation; apply the one or more numerical damage models to the 3D sub-model to simulate the hydraulic fracturing effects of the one or more stages of the multistage hydraulic fracturing treatment on the casing along the planned trajectory of the wellbore within the subsurface formation, based on the simulation using the 3D global model; and estimate at least one value of casing deformation along the planned trajectory of the wellbore, based on the simulation using the 3D sub-model.

In one or more embodiments of the foregoing system, the value of casing deformation may be estimated for one or more sections of the wellbore that correspond to the one or more stages of the multistage hydraulic fracturing treatment and/or each of a plurality of fluid injection pressures associated with the one or more stages of the multistage hydraulic fracturing treatment. The wellbore may be a horizontal wellbore, and the estimated value of casing deformation may be a maximum value of at least one of a lateral displacement or a vertical displacement estimated for the casing associated with each of the one or more sections along the planned trajectory of the horizontal wellbore within the subsurface formation. The one or more numerical damage models may be applied to each of the 3D global model and the 3D sub-model to simulate an asymmetrical distribution of fractures generated by the one or more stages of the multistage hydraulic fracturing treatment within the subsurface formation. The material parameters may include an elasticity modulus, and the asymmetrical distribution of fractures may be simulated by varying values of the elasticity modulus assigned to the different points of the subsurface formation corresponding to the selected portion modeled by the 3D sub-model. Such different points may include: a first set of points corresponding to a first area of the selected portion on one side of the planned trajectory of the wellbore having a relatively low density of natural fractures; a second set of points corresponding to a second area of the selected portion on another side of the planned trajectory of the wellbore having a relatively high density of natural fractures; and a third set of points corresponding to a location of a cement ring surrounding the casing. The values of the elasticity modulus assigned to points of the 3D sub-model corresponding to the second set of points may be relatively lower than those assigned to points of the 3D sub-model corresponding to the first set of points. The values of the elasticity modulus assigned to points of the 3D sub-model corresponding to the third set of points may be based on a quality of cementing material associated with different segments of the cement ring. The one or more numerical damage models may be applied to the 3D sub-model to simulate a stiffness degradation of the cementing material associated with one or more of the different segments of the cement ring based on the values of the elasticity modulus assigned to corresponding points of the 3D sub-model.

Further, the functions performed by the processor may include functions to: generate a refined version of the 3D sub-model based on the simulated stiffness degradation of the cementing material; apply the one or more numerical damage models to the refined version of the 3D sub-model to simulate the stiffness degradation of the cementing material; and estimate at least one refined value of casing deformation along the planned trajectory of the wellbore, based on the simulation using the refined version of the 3D sub-model. In some implementations, the functions performed by the processor may further include functions to determine one or more design parameters for each stage of the multistage hydraulic fracturing treatment to be performed along the planned trajectory of the wellbore, based on the estimated value of casing deformation. The one or more design parameters may include one or more of a maximum fluid injection pressure for each stage of the multistage hydraulic fracturing treatment and a quality of cementing material associated with the casing within one or more sections of the wellbore along the planned trajectory.

While specific details about the above embodiments have been described, the above hardware and software descriptions are intended merely as example embodiments and are not intended to limit the structure or implementation of the disclosed embodiments. For instance, although many other internal components of the system 1200 are not shown, those of ordinary skill in the art will appreciate that such components and their interconnection are well known.

In addition, certain aspects of the disclosed embodiments, as outlined above, may be embodied in software that is executed using one or more processing units/components. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives, optical or magnetic disks, and the like, which may provide storage at any time for the software programming.

Additionally, the flowchart and block diagrams in the figures illustrate the architecture, functionality, and operation of possible implementations of systems, methods and computer program products according to various embodiments of the present disclosure. It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The above specific example embodiments are not intended to limit the scope of the claims. The example embodiments may be modified by including, excluding, or combining one or more features or functions described in the disclosure.

As used herein, the singular forms “a”, “an” and “the” are intended to include the plural forms as well, unless the context clearly indicates otherwise. It will be further understood that the terms “comprise” and/or “comprising,” when used in this specification and/or the claims, specify the presence of stated features, integers, steps, operations, elements, and/or components, but do not preclude the presence or addition of one or more other features, integers, steps, operations, elements, components, and/or groups thereof. The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the embodiments in the form disclosed. Many modifications and variations will be apparent to those of ordinary skill in the art without departing from the scope and spirit of the disclosure. The illustrative embodiments described herein are provided to explain the principles of the disclosure and the practical application thereof, and to enable others of ordinary skill in the art to understand that the disclosed embodiments may be modified as desired for a particular implementation or use. The scope of the claims is intended to broadly cover the disclosed embodiments and any such modification.

What is claimed is:

1. A computer-implemented method of modeling casing deformation for hydraulic fracturing design, the method comprising:
generating a three-dimensional (3D) global model of a subsurface formation targeted for a multistage hydraulic fracturing treatment to be performed along a planned trajectory of a wellbore within the subsurface formation;
calculating values of material parameters for different points of the subsurface formation represented by the 3D global model, based on a geomechanical analysis of well log data obtained for the subsurface formation;
assigning the calculated values to corresponding points of the 3D global model;
generating a 3D sub-model of a selected portion of the subsurface formation including a casing to be placed along the planned trajectory of the wellbore within the subsurface formation, based at least partly on the values assigned to the 3D global model;
applying one or more numerical damage models to the 3D global model to simulate hydraulic fracturing effects of one or more stages of the multistage hydraulic fracturing treatment on the subsurface formation;
applying the one or more numerical damage models to the 3D sub-model to simulate the hydraulic fracturing effects of the one or more stages of the multistage hydraulic fracturing treatment on the casing along the planned trajectory of the wellbore within the subsurface formation, based on the simulation using the 3D global model; and
estimating at least one value of casing deformation along the planned trajectory of the wellbore, based on the simulation using the 3D sub-model.

2. The method of claim 1, wherein the value of casing deformation is estimated for each of a plurality of fluid injection pressures associated with the one or more stages of the multistage hydraulic fracturing treatment.

3. The method of claim 1, wherein the wellbore is a horizontal wellbore, the value of casing deformation is estimated for one or more sections of the horizontal wellbore that correspond to the one or more stages of the multistage hydraulic fracturing treatment, and the estimated value of casing deformation is a maximum value of at least one of a lateral displacement or a vertical displacement estimated for the casing associated with each of the one or more sections along the planned trajectory of the horizontal wellbore within the subsurface formation.

4. The method of claim 1, further comprising:
determining one or more design parameters for each stage of the multistage hydraulic fracturing treatment to be performed along the planned trajectory of the wellbore, based on the estimated value of casing deformation, the one or more design parameters including one or more of a maximum fluid injection pressure for each stage of the multistage hydraulic fracturing treatment and a quality of cementing material associated with the casing within one or more sections of the wellbore along the planned trajectory.

5. The method of claim 1, wherein the one or more numerical damage models are applied to each of the 3D global model and the 3D sub-model to simulate an asymmetrical distribution of fractures generated by the one or more stages of the multistage hydraulic fracturing treatment within the subsurface formation.

6. The method of claim 5, wherein:
the material parameters include an elasticity modulus, the asymmetrical distribution of fractures is simulated by varying values of the elasticity modulus assigned to the different points of the subsurface formation corresponding to the selected portion modeled by the 3D sub-model; and
the different points include:
a first set of points corresponding to a first area of the selected portion on one side of the planned trajectory of the wellbore having a relatively low density of natural fractures;
a second set of points corresponding to a second area of the selected portion on another side of the planned trajectory of the wellbore having a relatively high density of natural fractures; and
a third set of points corresponding to a location of a cement ring surrounding the casing.

7. The method of claim 6, wherein:
the values of the elasticity modulus assigned to points of the 3D sub-model corresponding to the second set of points are relatively lower than those assigned to points of the 3D sub-model corresponding to the first set of points;
the values of the elasticity modulus assigned to points of the 3D sub-model corresponding to the third set of points are based on a quality of cementing material associated with different segments of the cement ring; and
the one or more numerical damage models are applied to the 3D sub-model to simulate a stiffness degradation of the cementing material associated with one or more of the different segments of the cement ring based on the values of the elasticity modulus assigned to corresponding points of the 3D sub-model.

8. The method of claim 7, further comprising:
generating a refined version of the 3D sub-model based on the simulated stiffness degradation of the cementing material;
applying the one or more numerical damage models to the refined version of the 3D sub-model to simulate the stiffness degradation of the cementing material; and
estimating at least one refined value of casing deformation along the planned trajectory of the wellbore, based on the simulation using the refined version of the 3D sub-model.

9. A system comprising:
at least one processor; and
a memory coupled to the processor having instructions stored therein, which when executed by the processor, cause the processor to perform functions including functions to:
generate a three-dimensional (3D) global model of a subsurface formation targeted for a multistage hydraulic fracturing treatment to be performed along a planned trajectory of a wellbore within the subsurface formation;
calculate values of material parameters for different points of the subsurface formation represented by the 3D global model, based on a geomechanical analysis of well log data obtained for the subsurface formation;
assign the calculated values to corresponding points of the 3D global model;
generate a 3D sub-model of a selected portion of the subsurface formation including a casing to be placed along the planned trajectory of the wellbore within the subsurface formation, based at least partly on the values assigned to the 3D global model;
apply one or more numerical damage models to the 3D global model to simulate hydraulic fracturing effects of one or more stages of the multistage hydraulic fracturing treatment on the subsurface formation;
apply the one or more numerical damage models to the 3D sub-model to simulate the hydraulic fracturing effects of the one or more stages of the multistage hydraulic fracturing treatment on the casing along the planned trajectory of the wellbore within the subsurface formation, based on the simulation using the 3D global model; and
estimate at least one value of casing deformation for each of a plurality of fluid injection pressures associated with the one or more stages of the multistage hydraulic fracturing treatment along the planned trajectory of the wellbore, based on the simulation using the 3D sub-model, the value of casing deformation representing at least one of a maximum lateral displacement value or a maximum vertical displacement value of the casing for one or more sections of the wellbore along the planned trajectory.

10. The system of claim 9, wherein the functions performed by the processor further include functions to:
determine one or more design parameters for each stage of the multistage hydraulic fracturing treatment to be performed along the planned trajectory of the wellbore, based on the estimated value of casing deformation, the one or more design parameters including one or more of a maximum fluid injection pressure for each stage of the multistage hydraulic fracturing treatment and a quality of cementing material associated with the casing within one or more sections of the wellbore along the planned trajectory.

11. The system of claim 9, wherein the one or more numerical damage models are applied to each of the 3D global model and the 3D sub-model to simulate an asymmetrical distribution of fractures generated by the one or more stages of the multistage hydraulic fracturing treatment within the subsurface formation.

12. The system of claim 11, wherein the material parameters include an elasticity modulus, the asymmetrical distribution of fractures is simulated by varying values of the elasticity modulus assigned to the different points of the subsurface formation corresponding to the selected portion modeled by the 3D sub-model, and the different points include: a first set of points corresponding to a first area of the selected portion on one side of the planned trajectory of the wellbore having a relatively low density of natural fractures; a second set of points corresponding to a second area of the selected portion on another side of the planned trajectory of the wellbore having a relatively high density of natural fractures; and a third set of points corresponding to a location of a cement ring surrounding the casing.

13. The system of claim 12, wherein the values of the elasticity modulus assigned to points of the 3D sub-model corresponding to the second set of points are relatively lower than those assigned to points of the 3D sub-model corresponding to the first set of points, the values of the elasticity modulus assigned to points of the 3D sub-model corresponding to the third set of points are based on a quality of cementing material associated with different segments of the cement ring, and the one or more numerical damage models are applied to the 3D sub-model to simulate a stiffness degradation of the cementing material associated with one or more of the different segments of the cement ring based on the values of the elasticity modulus assigned to corresponding points of the 3D sub-model.

14. The system of claim 13, wherein the functions performed by the processor further include functions to:
generate a refined version of the 3D sub-model based on the simulated stiffness degradation of the cementing material;
apply the one or more numerical damage models to the refined version of the 3D sub-model to simulate the stiffness degradation of the cementing material; and
estimate at least one refined value of casing deformation along the planned trajectory of the wellbore, based on the simulation using the refined version of the 3D sub-model.

15. A computer-readable storage medium having instructions stored therein, which when executed by a computer cause the computer to perform a plurality of functions, including functions to:
generate a three-dimensional (3D) global model of a subsurface formation targeted for a multistage hydraulic fracturing treatment to be performed along a planned trajectory of a wellbore within the subsurface formation;
calculate values of material parameters for different points of the subsurface formation represented by the 3D global model, based on a geomechanical analysis of well log data obtained for the subsurface formation;
assign the calculated values to corresponding points of the 3D global model;
generate a 3D sub-model of a selected portion of the subsurface formation including a casing to be placed along the planned trajectory of the wellbore within the subsurface formation, based at least partly on the values assigned to the 3D global model;
apply one or more numerical damage models to the 3D global model to simulate hydraulic fracturing effects of one or more stages of the multistage hydraulic fracturing treatment on the subsurface formation;
apply the one or more numerical damage models to the 3D sub-model to simulate the hydraulic fracturing effects of the one or more stages of the multistage hydraulic fracturing treatment on the casing along the planned trajectory of the wellbore within the subsurface formation, based on the simulation using the 3D global model; and
estimate at least one value of casing deformation for each of a plurality of fluid injection pressures associated with the one or more stages of the multistage hydraulic fracturing treatment along the planned trajectory of the wellbore, based on the simulation using the 3D sub-model, the value of casing deformation representing at least one of a maximum lateral displacement value or a maximum vertical displacement value of the casing for one or more sections of the wellbore along the planned trajectory.

16. The computer-readable storage medium of claim 15, wherein the functions performed by the computer further include functions to:
determine one or more design parameters for each stage of the multistage hydraulic fracturing treatment to be performed along the planned trajectory of the wellbore, based on the estimated value of casing deformation, the one or more design parameters including one or more of a maximum fluid injection pressure for each stage of the multistage hydraulic fracturing treatment and a quality of cementing material associated with the casing within one or more sections of the wellbore along the planned trajectory.

17. The computer-readable storage medium of claim 16, wherein the one or more numerical damage models are applied to each of the 3D global model and the 3D sub-model to simulate an asymmetrical distribution of fractures generated by the one or more stages of the multistage hydraulic fracturing treatment within the subsurface formation.

18. The computer-readable storage medium of claim 17, wherein the material parameters include an elasticity modulus, the asymmetrical distribution of fractures is simulated by varying values of the elasticity modulus assigned to the different points of the subsurface formation corresponding to the selected portion modeled by the 3D sub-model, and the different points include: a first set of points corresponding to a first area of the selected portion on one side of the planned trajectory of the wellbore having a relatively low density of natural fractures; a second set of points corresponding to a second area of the selected portion on another side of the planned trajectory of the wellbore having a relatively high density of natural fractures; and a third set of points corresponding to a location of a cement ring surrounding the casing.

19. The computer-readable storage medium of claim 18, wherein the values of the elasticity modulus assigned to points of the 3D sub-model corresponding to the second set of points are relatively lower than those assigned to points of the 3D sub-model corresponding to the first set of points, the values of the elasticity modulus assigned to points of the 3D sub-model corresponding to the third set of points are based on a quality of cementing material associated with different segments of the cement ring, and the one or more numerical damage models are applied to the 3D sub-model to simulate a stiffness degradation of the cementing material associated with one or more of the different segments of the cement ring based on the values of the elasticity modulus assigned to corresponding points of the 3D sub-model.

20. The computer-readable storage medium of claim 19, wherein the functions performed by the computer further include functions to:
generate a refined version of the 3D sub-model based on the simulated stiffness degradation of the cementing material;
apply the one or more numerical damage models to the refined version of the 3D sub-model to simulate the stiffness degradation of the cementing material; and
estimate at least one refined value of casing deformation along the planned trajectory of the wellbore, based on the simulation using the refined version of the 3D sub-model.
